(19) United States
(12) Patent Application Publication
(10) Pub. No.: US 2026/0231049 A1
(43) Pub. Date: Aug. 6, 2026

(54) COEXISTENCE TECHNIQUES OF IMPLEMENTING SBFD AND TDD NETWORK CONFIGURATIONS

(71) Applicant: Charter Communications Operating, LLC, St. Louis, MO (US)

(72) Inventors: Yehuda Yuda Luz, Buffalo Grove, IL (US); Muhammad Usman Fazili, Audubon, PA (US); Francisco A. Azcuy, Miami, FL (US)

(21) Appl. No.: 19/530,989

(22) Filed: Feb. 5, 2026

Related U.S. Application Data
(60) Provisional application No. 63/754,964, filed on Feb. 6, 2025.

(51) Int. Cl. H04W 52/24; H04L 5/14

(52) U.S. Cl. CPC H04W 52/243; H04L 5/14

(57) ABSTRACT

A first wireless station in a network environment measures wireless interference associated with a wireless channel. The first wireless station produces wireless interference information indicating the level of wireless interference measured at the first wireless station. The first wireless station communicates the wireless interference information to a second wireless station in the network environment. The second wireless station calculates a transmit power level for communicating with the first wireless station based on the measured level of interference at the first wireless station. Based on the calculated transmit power level, the second wireless station controls transmission of wireless signals from a second wireless station to the first wireless station. Further, the first wireless station or other suitable entity can be configured to control transmission of SBFD communications and non-SBFD communications with respect to one or more threshold levels.

### RELATED APPLICATION

This application claims the benefit of earlier filed U.S. Patent Application Ser. No. 63/754,964 entitled “METHOD TO ENABLE FAIR COEXISTENCE BETWEEN SBFD AND TDD NETWORKS,” (Attorney Docket No. CHTR-2025-17P), filed on Feb. 6, 2025, the entire teachings of which are incorporated herein by this reference.

### BACKGROUND

Conventional wireless networks typically include one or more wireless base stations or wireless access points to provide mobile communication devices (a.k.a., user equipment) access to a remote network such as the Internet or other target communication servers at remote locations. In certain instances, the wireless networks include many different types of networks and/or components that must collectively work together to provide wireless services.

One conventional type of wireless network is a so-called 5G wireless network. A 5G wireless network typically includes at least one so-called 5G radio access network (RANs) and corresponding 5G core network. A conventional 5G wireless base station may be connected to a 5G core network via an IP (Internet Protocol) network commonly referred to as a backhaul. 5G networks implement dynamic policies to enforce traffic control.

It is further noted that a network environment can be configured to include multiple wireless networks, each supported by a different communication configuration such as a time division duplex configuration, sub-band full-duplex configuration, etc.

In a conventional 5G network, TDD (Time Division Duplexing) shares one frequency by switching between uplink (UL) and downlink (DL) in different time slots. In other words, each time slot in a time-division duplex configuration is assigned to support only uplink communications or only downlink communications. In contrast to TDD, a so-called SBFD (Sub-Band Full Duplex) configuration supports simultaneous UL and DL transmissions using different sub-bands in the same time slot.

### BRIEF DESCRIPTION

Techniques as discussed herein include novel ways of controlling wireless transmitter power based upon detected wireless interference levels at a wireless station.

More specifically, a first wireless station in a network environment measures wireless interference associated with a first wireless channel supporting sub-band full-duplex communications with a second wireless station. The first wireless station produces wireless interference information indicating the level of wireless interference measured at the first wireless station for the first wireless channel. The wireless interference information can be used to control a power level of transmitting SBFD communications. For example, the first wireless station can be configured to communicate the wireless interference information (such as including adjustment information) to a second wireless station in the network environment. The second wireless station or other suitable entity calculates a transmit power level for communicating with the first wireless station over the first wireless channel based on the measured level of interference at the first wireless station. Based on the calculated transmit power level accounting for the wireless interference measured by the first wireless station, the second wireless station controls transmission of wireless signals (such as sub-band full-duplex communications) from the second wireless station to the first wireless station based on the calculated transmit power level.

In further examples as discussed herein, the first wireless station such as a wireless base station provides wireless connectivity to a first set of wireless stations including the second wireless station.

In another example, the level of wireless interference is measured at the first wireless station during a condition in which the wireless stations in the first set are prevented from wirelessly transmitting signals in the first wireless channel to the first wireless station. The wireless interference measured at the first wireless station is potentially caused by a third wireless station wirelessly communicating messages to a fourth wireless station in the network environment. The messages may be wirelessly communicated from the third wireless station over a non-sub-band full-duplex wireless channel (such as a wireless channel supporting time division duplex communications).

In further examples as discussed herein, the measured level of wireless interference indicates or includes a wireless interference power level or power adjustment value. Calculation of the transmit power level to be used by the second wireless station may include generating the transmit power level based at least in part on the power adjustment value (wireless interference).

Still further, in one example, controlled transmission of the wireless signals from the second wireless station includes the second wireless station transmitting the wireless signals such as SBFD communications over the wireless channel to the first wireless station, where the wireless signals are transmitted at the calculated transmit power level.

Yet further, it is noted that the wireless signals transmitted from the second wireless station are received at the first wireless station at a greater power level than the measured level of wireless interference at the first wireless station. This ensures that the first wireless station receives the wireless signals transmitted from the second wireless station.

The wireless interference information as discussed herein may include any suitable information. In one example, the wireless interference information is transmitted from the first wireless station to the second wireless station; the transmit power level for communicating with the first wireless station is calculated at the second wireless station or other suitable entity.

In yet further examples as discussed herein, the controlled transmission of the first wireless signals from the second wireless station to the first wireless station based on the calculated transmit power level includes the first wireless station or other suitable entity: assigning the second wireless station a time slot in which to transmit the first wireless signals over the first wireless channel to the second wireless station; assigning the second wireless station a first bandwidth portion (such as one or more carrier frequencies) of the first wireless channel to transmit the first wireless signals; and notifying the second wireless station of the assigned time slot and the first bandwidth portion in which to transmit the first wireless signals.

Controlled transmission of the SBFD communications may further include the first wireless station or other suitable entity: i) receiving the first wireless signals transmitted from the second wireless station in the first time slot to the first wireless station, where the wireless signals are transmitted by the second wireless station to the first wireless station in the first bandwidth portion of the first wireless channel, and ii) transmitting second wireless signals from the first wireless station over a second bandwidth portion of the first wireless channel during the assigned time slot, where the first wireless signals and the second wireless signals are SBFD communications. Thus, the assigned time slot can be used to support simultaneous conveyance of first wireless communications from the second wireless station to the first wireless station as well as conveyance of second wireless communications from the first wireless station to the second wireless station.

In one example, the communication management resource as discussed herein receives a first power threshold level and a second power threshold level. The communication management resource such as associated with a mobile communication device and/or a wireless base station control conveyance of non-sub-band full-duplex wireless communications over a wireless channel, where the non-sub-band full-duplex wireless communications are limited to transmission below the first power threshold level to reduce wireless interference to other wireless stations. The communication management resource also controls conveyance of sub-band full-duplex wireless communications over the wireless channel, where the sub-band full-duplex wireless communications are limited to transmission below the second power threshold level, the second power threshold level less than the first power threshold level.

In another example, techniques herein include a communication management resource such as associated with a first wireless station receiving a first power threshold level. The communication management resource or other suitable entity controls conveyance of TDD (Time Division Duplex) wireless communications and SBFD (Sub-Band Full-Duplex) wireless communications over a wireless channel. In one example, the controlled conveyance of the SBFD wireless communications includes the communication management resource preventing transmission of the SBFD wireless communications over the wireless channel at first wireless power levels greater than the first power threshold level.

The limiting of the power of transmitting SBDF communications in certain instances as discussed herein reduces an amount of wireless interference in the network environment.

In one example, controlling conveyance of the TDD wireless communications over the wireless channel includes the communication management resource or other suitable entity enabling transmission of the TDD wireless communications over the wireless channel at second wireless power levels greater than the first power threshold level and less than the first power threshold level.

In accordance with further examples, the communication management resource or other suitable entity can be configured to estimate a first wireless power level of transmitting first communications in an uplink direction from a first mobile communication device to a wireless base station. Based on comparing the first wireless power level to the first power threshold level, the communication management resource controls transmission of the first communications from the first mobile communication device to the wireless base station.

Still further examples as discussed herein include in response to detecting that the first wireless power level is greater than the first power threshold level, preventing the first mobile communication device from wirelessly transmitting the first communications as SBFD communications over the wireless channel. Conversely, in response to detecting that the first wireless power level is less than the first power threshold level, controlling the first mobile communication device to wirelessly transmit the first communications as SBFD communications over the wireless channel. Thus, the first mobile communication device is prevented from transmitting SBFD communications at power levels greater than the first power threshold level.

Yet further, control of SBFD communications as discussed herein may include the communication management resource or other suitable entity receiving first feedback from a first mobile communication device, where the first feedback indicates a first wireless power headroom available for the first mobile communication device to communicate in an uplink direction to a wireless base station. Based at least in part on a magnitude of the first wireless power headroom, the communication management resource prevents the first mobile communication device from transmitting the SBFD wireless communications from the first mobile communication device over the wireless channel to the wireless base station above the first power threshold level.

Additionally, the communication management resource can be configured to receive second feedback from a second mobile communication device, where the second feedback indicates a second wireless power headroom available for the second mobile communication device to communicate in the uplink direction to the wireless base station. Based at least in part on a magnitude of the second wireless power headroom, the communication management resource controls the second mobile communication device to transmit the SBFD wireless communications from the second mobile communication device over the wireless channel to the wireless base station at a wireless transmit power level below the first power threshold level.

In accordance with yet further examples as discussed herein, the SBFD wireless communications include may full power SBFD wireless communications and reduced power SBFD wireless communications. The communication management resource or other entity can be configured to receive a first value indicative of a first portion of mobile communication devices in a network to be provided support of transmitting the full power SBFD wireless communications. The communication management resource derives the first power threshold level based at least in part on the first value. If further, the communication management resource can be configured to receive a second value indicative of a second portion of mobile communication devices in the network to be provided support of transmitting the reduced power SBFD wireless communications. The communication management resource derives a second power threshold level based on the second value. Still further, the communication management resource can be configured to control conveyance of the full power SBFD wireless communications and the reduced power SBFD communications based on the first power threshold level and the second power threshold level.

In another example, the communication management resource 11 adjusts a magnitude of the first power threshold level depending upon a magnitude of wireless interference detected in a network environment.

In still further examples as discussed herein, the communication management resource can be configured to: receive a second power threshold level, the second power threshold level less than the first power threshold level; enable both a first group of wireless stations and a second group of wireless stations to transmit the SBFD wireless communications at first power levels below the second power threshold level; enable the first group of wireless stations to transmit SBFD wireless communications at second power levels that fall in a range between the second power threshold level and the first power threshold level; and prevent the second group of wireless stations from transmitting SBFD wireless communications at the second power levels between the first power threshold level and the second power threshold level. Further, the communication management resource can be configured to prevent both the first group of wireless stations and the second group of wireless stations from transmitting SBFD wireless communications at third power levels greater than the first power threshold level.

Techniques as discussed herein are useful over conventional techniques. For example, implementation of the one or more techniques as discussed herein supports fair coexistence between SBFD and TDD networks and corresponding wireless stations, resulting in lower interference and thus better use of limited wireless resources.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or any computer readable storage hardware on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium or computer readable hardware storage such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, computable readable storage hardware, etc., that supports operations as discussed herein.

One example as discussed herein includes computer readable storage hardware having instructions stored thereon. The instructions, when executed by corresponding computer processor hardware, cause the computer processor hardware (such as one or more co-located or disparately processor devices or hardware) to: receive wireless interference information indicating a level of wireless interference measured at a first wireless station for a first wireless channel supporting sub-band full-duplex wireless communications; calculate a transmit power level for communicating with the first wireless station based on the measured level of interference at the first wireless station; and control transmission of first wireless signals from a second wireless station to the first wireless station based on the calculated transmit power level.

Another example includes computer readable storage hardware having instructions stored thereon. The instructions, when executed by corresponding computer processor hardware, cause the computer processor hardware (such as one or more co-located or disparately processor devices or hardware) to: receive a first power threshold level; control conveyance of TDD (Time Division Duplex) wireless communications and SBFD (Sub-Band Full-Duplex) wireless communications over a wireless channel; and wherein the controlled conveyance of the SBFD wireless communications includes preventing transmission of the SBFD wireless communications over the wireless channel at first wireless power levels greater than the first power threshold level.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of supporting better use of wireless resources in coexisting time division duplex networks and SBFD networks. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment and scheduling of so-called SBFD (Sub-Band Full-Duplex) communications by a first wireless base station in the presence of a second wireless base station supporting so-called TDD (Time-Division Duplex) communications as discussed herein.

FIG. 2 is an example diagram illustrating wireless interference resulting from a wireless base station communicating in a respective wireless network environment as discussed herein.

FIG. 3 is an example diagram illustrating monitoring of wireless signals from one or more wireless base stations, determination of interference associated with the monitored wireless signals, and generation of wireless interference information as discussed herein.

FIG. 4 is an example diagram illustrating transmission of wireless interference information to a wireless station and corresponding use of the wireless interference by that wireless station to adjust its wireless power level of transmitting communications to a wireless base station as discussed herein.

FIG. 5 is an example diagram illustrating adjustment of a wireless power level of a mobile communication device transmitting communications to a wireless base station based on the wireless interference information as discussed herein.

FIG. 6 is an example diagram illustrating implementation of controlling/adjusting wireless power levels of multiple mobile communication devices transmitting SBFD communications to a wireless base station as discussed herein.

FIG. 7 is an example diagram implementation of a data field in a wireless communication for inclusion of wireless interference information or power level adjustment information as discussed herein.

FIG. 8 is an example diagram illustrating example computer hardware and software operable to execute operations as discussed herein.

FIG. 9 is an example diagram illustrating a method as discussed herein.

FIG. 10 is an example diagram illustrating wireless interference caused by a first mobile communication device to a second mobile communication device based on wireless transmission of SBFD communications as discussed herein.

FIG. 11 is an example diagram of limiting wireless transmit power levels of different mobile communication devices transmitting SBFD communications and non-SBFD communications as discussed herein.

FIG. 12 is an example method of limiting different wireless transmit power levels for SBFD communications and non-SBFD communications as discussed herein.

FIG. 13 is an example diagram illustrating limiting of a wireless power of transmitting SBFD communications as discussed herein.

FIG. 14 is an example diagram illustrating limiting of a wireless power level of transmitting SBFD communications as discussed herein.

FIG. 15 is an example diagram illustrating limiting of a wireless power level of transmitting SBFD communications as discussed herein.

FIG. 16 is an example diagram illustrating limiting of a wireless power level of transmitting SBFD communications as discussed herein.

FIG. 17 is an example diagram illustrating generation/adjustment of a power transmit threshold level to control a user equipment population transmitting SBFD communications versus non-SBFD communications as discussed herein.

FIG. 18 is an example diagram illustrating generation of a power headroom threshold level as discussed herein.

FIG. 19 is an example diagram illustrating selection/adjustment of a power threshold level to control transmission of SBFD communications as discussed herein.

FIG. 20 is an example diagram illustrating implementation of a power transmit threshold discussed herein.

FIG. 21 is an example diagram illustrating generation/adjustment of a respective power threshold level associated with transmission of SBFD communications and non-SBFD communications as discussed herein.

FIG. 22 is an example diagram illustrating implementation of a power threshold level to control transmission of SBFD communications and non-SBFD communications in a network environment as discussed herein.

FIG. 23 is an example diagram illustrating multiple power threshold levels to control power limits associated with transmitting SBFD communications and non-SBFD communications as discussed herein.

FIG. 24 is an example diagram illustrating generation of multiple power thresholds to control transmission of SBFD communications and non-SBFD communications discussed herein.

FIG. 25 is an example diagram illustrating generation of multiple power thresholds to control transmission of SBFD communications and non-SBFD communications as discussed herein.

FIG. 26 is an example diagram illustrating implementation of multiple power threshold levels to control transmission of SBFD communications and non-SBFD communications as discussed herein.

FIG. 27 is an example diagram illustrating implementation of a method of controlling a wireless power level of transmitting SBFD and non-SBFD communications as discussed herein.

FIG. 28 is an example diagram illustrating power headroom relative to distance and implementation of multiple power threshold levels as discussed herein.

FIG. 29 is an example diagram illustrating power headroom relative to distance and implementation of multiple threshold levels as discussed herein.

FIG. 30 is an example diagram illustrating generation of threshold levels and testing of same as discussed herein.

FIG. 31 is an example diagram illustrating implementation of multiple threshold levels to control transmission of communications as discussed herein.

FIG. 32 is an example diagram illustrating a method of generating multiple threshold levels to control transmission of communications as discussed herein.

FIG. 33 is an example method of implementing multiple threshold levels to control transmission of communications as discussed herein.

The foregoing and other objects, features, and advantages of the invention will be apparent from the following more particular description of preferred examples herein, as illustrated in the accompanying drawings in which reference characters refer to the same parts throughout the different views. The drawings are not necessarily to scale, with emphasis instead being placed upon illustrating the examples, principles, concepts, etc.

### DETAILED DESCRIPTION

As discussed herein, a first wireless station in a network environment measures wireless interference associated with a first wireless channel supporting sub-band full-duplex wireless communications. The first wireless station produces wireless interference information indicating the level of wireless interference measured at the first wireless station for the first wireless channel. The wireless interference information may include an adjustment value such as an interference value or interference factor. The first wireless station communicates the wireless interference information and corresponding power adjustment value (a.k.a., interference factor) or the like to a second wireless station in the network environment. The second wireless station calculates a transmit power level for communicating SBFD communications over the first wireless channel to the first wireless station based on the measured level of interference at the first wireless station as indicated by the power just value. Based on the calculated transmit power level, the second wireless station (such as user equipment) controls transmission of wireless signals (including SBFD communications) from a second wireless station to the first wireless station (such as wireless base station).

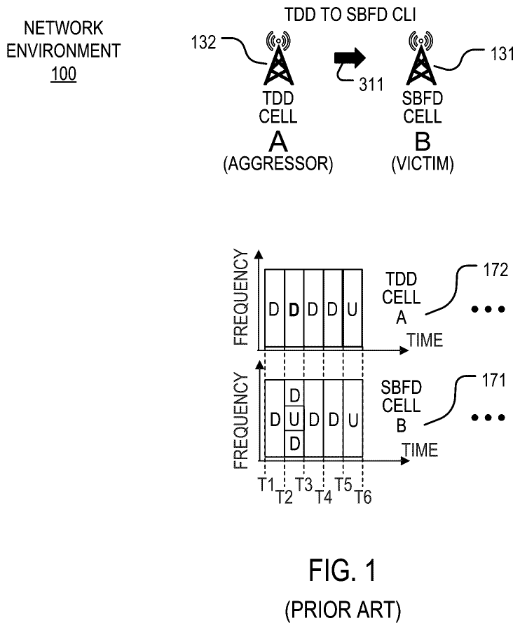

Now, more specifically, FIG. 1 is an example diagram illustrating a network environment and scheduling of so-called SBFD (Sub-Band Full Duplex) communications by a first wireless base station in the presence of a second wireless base station supporting so-called TDD (Time-Division Duplex) communications.

In this example, the network environment 100 includes wireless base station 131, wireless base station 132, etc.

Note that each of the wireless base stations and corresponding communication management resources in the network environment 100 is a wireless station supporting wireless communications with other wireless stations. Each wireless base station such as wireless base station 131, wireless base station 132, etc., may be a gNB or other suitable entity supporting wireless communications in the network environment 100.

As further shown in FIG. 1, the different wireless cells (such as cell B) in the network environment 100 can be configured to support so-called sub-band full duplex (SBFD) communications and time division duplex (TDD) communications.

Implementation of so-called Sub-Band Full Duplex (SBFD) allows a legacy TDD timeslot which was configured as “Downlink” (D) to include an Uplink subband bandwidth portion also allocated for Uplink (U) transmissions. This time-slot becomes Full Duplex because the wireless base station 131 (gNB) will simultaneously transmit in Downlink (D) and receive in Uplink (U) in the same time slot. The benefits of SBFD over legacy TDD are (1) reduced latency and (2) increased UL throughput.

Further in this example, in addition to supporting TDD communications, assume that the wireless base station 131 is configured to implement so-called SBFD communications in which a respective timeslot may be assigned to support simultaneous communications in both directions (uplink and downlink) over channel #1 between the wireless base station 131 and a corresponding mobile communication device.

More specifically, in this example of implementing sub-band full-duplex communications as indicated by the graph 171, the timeslot between time T1 time T2 is allocated to support TDD downlink communications from the wireless base station 131 to the respective mobile communication device; the timeslot between time T2 and time T3 is allocated to support SBFD communications such as including both uplink communications (such as based on one or more sub-carrier frequencies in the wireless channel #1) and downlink communications (such as based on one or more sub-carrier frequencies in the wireless channel #1); the timeslot between time T3 and time T4 is allocated to support TDD downlink communications; the timeslot between time T4 and time T5 is allocated to support TDD downlink communications; the timeslot between time T5 and time T6 is allocated to support TDD uplink communications from the respective mobile communication device to the wireless base station 131; and so on.

Channel #1 implemented by the wireless base station 131 may include one or more sub-carrier frequencies to support conveyance of respective wireless signals.

In contrast to wireless base station 131, assume that the wireless base station 132 supports so-called time division duplex communications (a.k.a., TDD) as indicated by the graph 172 in which a respective timeslot may be configured to support uplink only communications or downlink only communications using channel #1 or channel #2, where channel #2 is adjacent to channel #1.

In this example, for the graph 172 and corresponding TDD configuration supported by the wireless base station 132, the timeslot between time T1 and time T2 is allocated to support downlink communications from the wireless base station 132 to a respective mobile communication device; timeslot between time T2 and time T3 is allocated to support both downlink communications; timeslot between time T3 and time T4 is allocated to support downlink communications; timeslot between time T4 and time T5 is allocated support downlink communications; timeslot between time T5 and time T6 is allocated to support uplink communications from a respective mobile communication device to the wireless base station 132; and so on.

As further discussed herein, transmission of the downlink wireless signals 311 such as over channel #1 or channel #2 by the wireless base station 132 or other suitable one or more entities results in undesirable wireless interference to the wireless base station 131. In other words, when the wireless base station 132 transmits wireless signals 311 such as over channel #1 or channel #2, this causes wireless interference in wireless channel #1 used by the wireless base station 131. The wireless base station 131 is a so-called victim because the presence of the wireless interference (noise) caused by the wireless signals 311 transmitted by the wireless base station 132 makes it difficult for the wireless base station 131 to receive wireless signals from one or more mobile communication devices in the network environment 100.

Thus, unfortunately, an operator “A” implementing legacy TDD (see graph 172) at wireless base station 132 may cause adjacent channel cross link interference (CLI) to a nearby operator “B” implementing SBFD at the wireless base station 131 in the timeslot between time T2 and time T3. This wireless interference (such as gNB-to-gNB example) in the timeslot is caused by the wireless base station 132 (gNB) of operator “A” transmitting (such as in the downlink direction) during the said SBFD timeslot (between time T2 and time T3) of operator “B” while its base-station “B” or wireless base station 131 is trying to receive the UL sub-band (a.k.a., uplink) from its own SBFD UE “B”.

It is further noted that the level of this wireless interference is worse when a respective SBFD UE “B” is located at cell edge and its uplink transmitted signal is received poorly by the victim gNB “B” (wireless base station 131) relative to the interference power from aggressor gNB “A”. The wireless interference may further become worse if the two networks use adjacent carrier frequencies, and if the grid shift between the two networks is 10%.

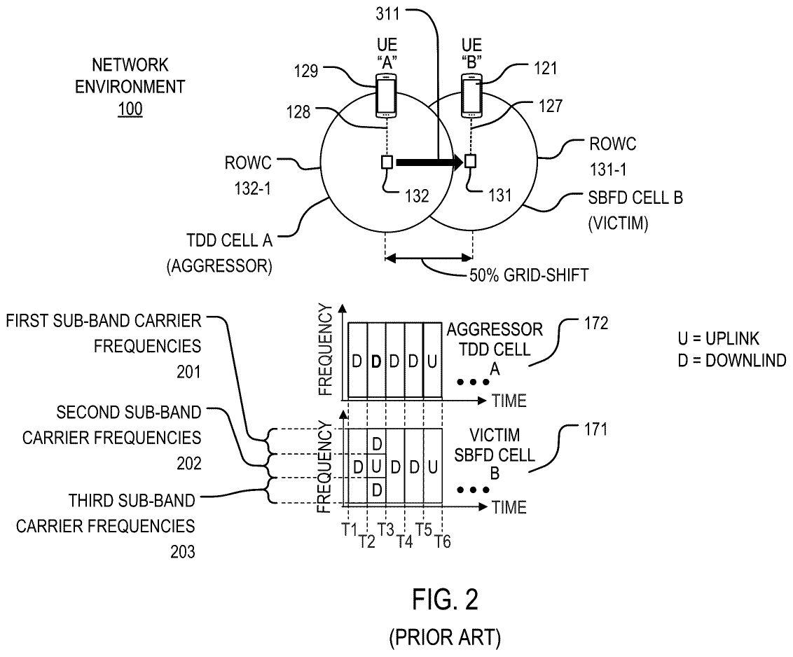

FIG. 2 is an example diagram illustrating simultaneous use of different portions of a frequency band to support uplink communications, downlink communications, and simultaneous uplink/downlink communications in accordance with SBFD as discussed herein.

In this example, the wireless base station 131 implementing wireless channel #1 and corresponding SBFD communication configuration (graph 171) supports a region of wireless coverage 131-1 in the network environment 100. The wireless base station 131 is in wireless communication with the mobile communication device 121 over the wireless the communication link 127. The mobile communication device 121 may reside on or near a respective edge of the cell (a.k.a., region of wireless coverage 131-1).

The wireless base station 132 supports a region of wireless coverage 132-1 in the network environment 100. The wireless base station 132 is in wireless communication with the mobile communication device 129 over the wireless communication link 128. The mobile communication device 129 may reside on or near a respective edge of the cell (a.k.a., region of wireless coverage 132-1).

As previously discussed, the TDD to SBFD cross-link interference of implementing cell A and cell B causes a gNB-to-gNB wireless interference issue. The cross link interference (a.k.a., wireless interference) is worse when the two nearby cells such as wireless base stations use adjacent channel frequencies (wireless base station 131 uses wireless channel #1 and wireless base station 132 uses wireless channel #2).

It is especially worse when UE “A” is located at its serving cell “A” edge and similarly UE “B” is located at its serving cell edge.

In this example, FIG. 2 illustrates a 50% grid shift (the ideal case) of distance between the two operators and corresponding cells. It is noted that this is not the worst case. It is possible that there is a 5% grid shift between the TDD cell (region of wireless coverage 132-1) and the SBFD cell (region of wireless coverage 131-1), which may be more realistic in actual practice.

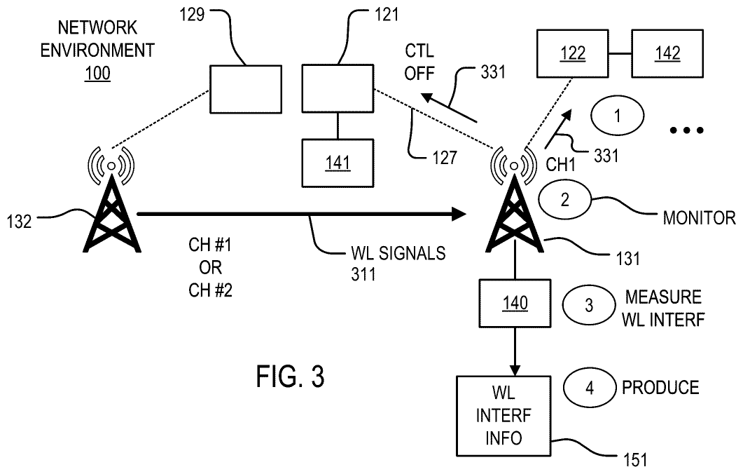

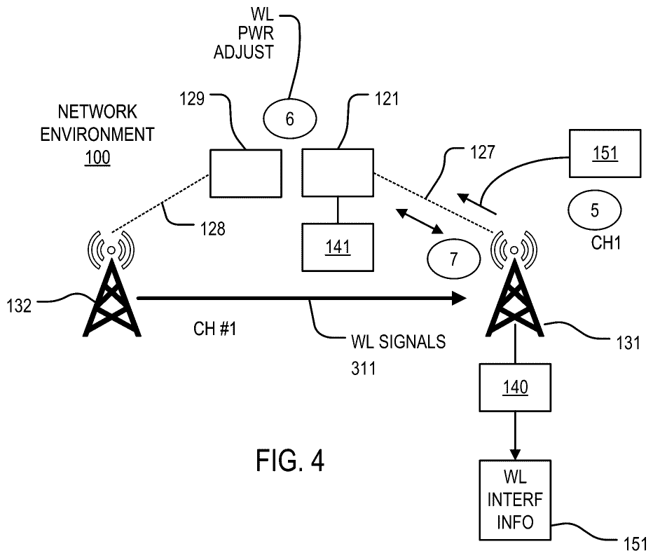

For a respective wireless signal from the wireless base station 132 to reach its far-away UE “A” such as mobile communication device 129, the aggressor TDD cell “A” and corresponding wireless base station 132 may use its downlink timeslot by transmitting at full wireless power, resulting in the victim gNB “B” such as wireless base station 131 having difficulty in receiving wireless communications from its UE “B” such as mobile communication device 121 transmitting in the uplink direction to the wireless base station 131. Additionally, it is noted that UE “B” (121) may be located far-away from the wireless base station 131. In such an instance, the wireless signals transmitted by the mobile communication device 121 to the wireless base station 131 may be received at a weak wireless power level relative to the wireless signal strength of the wireless base station 131 receiving the wireless signals 311 transmitted from the wireless base station 132, which may cause the victim gNB “B” such as wireless base station 131 to discontinue providing wireless service to the mobile communication device 121. The techniques as further discussed herein provide a solution to this interference issue. For example, the combination of FIG. 3 and FIG. 4 and other FIGS. illustrate and describe operations associated with controlling/adjusting a signal strength of transmitting SBFD communications in an uplink direction from the mobile communication device 121 to the wireless base station 131 based on detected wireless interference caused by at least the wireless base station 132 and other wireless stations communicating the network environment 100.

More specifically, FIG. 3 is an example diagram illustrating wireless interference monitoring and generation of wireless interference information as discussed herein.

As previously discussed, the wireless base station 131 transmits the wireless signals 311 in wireless channel #1 or wireless channel #2.

In processing operation #1, in order to support SBFD communications as discussed herein, the wireless base station 131 and corresponding communication management resource 140 notify or control the mobile communication device 121 and mobile communication device 122 to discontinue transmitting wireless communications in an uplink direction to the wireless base station 131 over the wireless channel #1 such as prior to time T1 (graph 171 or graph 172). This may include the wireless base station 131 not scheduling the mobile communication device 121 and the mobile communication device 122 wireless resources to transmit in the uplink direction to the wireless base station 131 in this timeslot. In one example, the wireless base station 131 transmits the communications 331 to prevent the mobile communication devices from transmitting wireless signals. This ensures that the following one or more operations of measuring wireless interference in the network environment 100 is not caused by the mobile communication device 121 or mobile communication device 122.

In processing operation #2, while the mobile communication device 121 and the mobile communication device 122 do not transmit wireless communications to the wireless base station 131 in the uplink direction in a timeslot prior to time T1, the wireless base station 131 monitors a signal strength of any wireless signals or noise present in the wireless channel #1, which may be detected as interference based on transmission of the wireless signals 311 transmitted by the wireless base station 132 in wireless channel #1 or the wireless channel #2 or any other wireless stations transmitting in the network environment 100.

In processing operation #3, based on the monitoring of the received wireless signals 311 or any other detected noise or interference in wireless channel #1 prior to time T1, the communication management resource 140 associated with the wireless base station 131 measures the wireless interference in wireless channel #1.

In processing operation #4, based on the measurement of the detected wireless interference in wireless channel #1, the communication management resource 140 produces the wireless interference information 151. The wireless interference information 151 indicates the wireless noise level or wireless interference level associated with the wireless base station 131 receiving any wireless signals in the channel #1 prior to time T1 when the mobile communication device 121 and mobile communication device 122 do not transmit wireless signals. Processing continues as shown and further discussed in FIG. 4.

FIG. 4 is an example diagram illustrating transmission of wireless interference information to a wireless station and use of the wireless interference by that wireless station to adjust its wireless power level of transmitting communications to a wireless base station as discussed herein.

In processing operation #5, the wireless base station 131 transmits the wireless interference information 151 to the mobile communication device 121, where the wireless interference information 151 may indicate the corresponding wireless interference detected in processing operation #2 prior to time T1.

In processing operation #5, the wireless base station 131 may also allocate wireless SBFD resources in the channel #1 and corresponding timeslot between time T2 and time T3 to the mobile communication device 121, where the allocated wireless resources support SBFD communications (see graph 171). In other words, during the timeslot between time T2 and time T3, a set of one or more sub-band carrier frequencies 202 in channel #1 are allocated/assigned to the mobile communication device 121 for use by the mobile communication device 121 to communicate in an uplink direction over the wireless communication link 127 to the wireless base station 131. Additionally, during the timeslot between time T2 and time T3, a second set of one or more sub-band carrier frequencies (such as sub-band carrier frequencies 201 and sub-band carrier frequencies 203) in channel #1 are allocated/assigned to transmit wireless communications from the wireless base station 131 in the downlink direction from the wireless base station 131 over the wireless communication link 127 to the mobile communication device 121. Thus, as previously discussed, the timeslot between time T2 and time T3 supports so-called SBFD communications (such as simultaneous bidirectional communications) unlike the TDD timeslot supporting only uplink or only downlink communications.

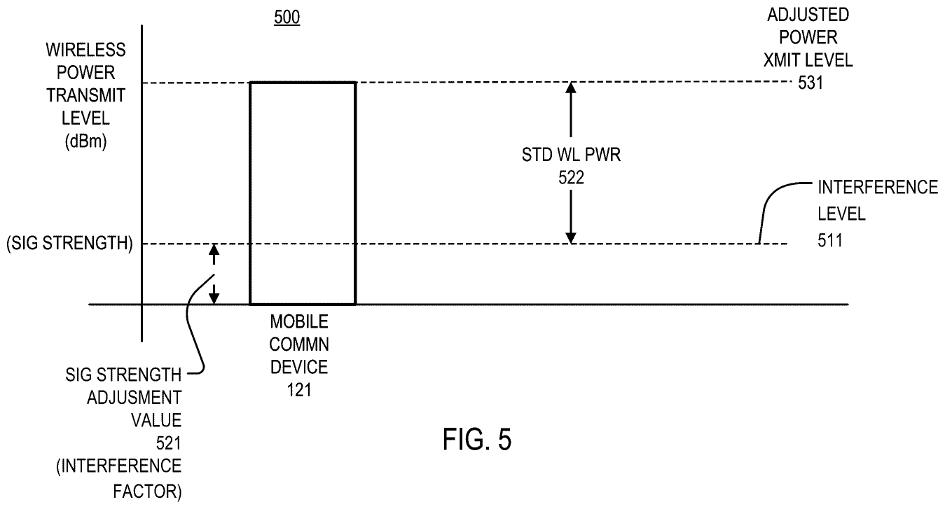

In processing operation #6, the mobile communication device 121 and corresponding communication management resource 141 process the received wireless interference information 151 to determine a respective wireless power level to be used when transmitting subsequent wireless SBFD communications in an uplink direction over the wireless communication link 127 to the wireless base station 131 in the timeslot between time T2 and time T3 using the sub-band carrier frequencies 202. An example of using the received wireless interference information 151 to determine the wireless transmit power level associated with the mobile communication device 121 transmitting the SBFD communications is further shown and discussed in FIG. 5.

Referring again to FIG. 4, in processing operation #7, in the timeslot between time T2 and time T3, the wireless communication link 127 supports simultaneous bidirectional (both uplink and downlink) transmission of wireless signals between the wireless base station 131 and the mobile communication device 121. For example, using the allocated/assigned first set of one or more carrier frequencies (such as set of carrier frequencies 202) supporting the uplink communications, the mobile communication device 121 transmits (such as at the adjusted signal strength or power level in FIG. 5 using the interference factor or wireless interference information 151) the respective uplink wireless communications in the timeslot between time T2 and time T3. Using the allocated/assigned second set of one or more carrier frequencies (such as set of carrier frequencies 201 and set of carrier frequencies 203) supporting the downlink communications, the wireless base station 131 simultaneously transmits the respective downlink wireless communications over the wireless communication link 127 to the mobile communication device 121 in the timeslot between time T2 and time T3 while the wireless base station 131 receives the uplink transmitted communications from the mobile communication device 121.

FIG. 5 is an example diagram illustrating adjustment of a wireless power level of a mobile communication device transmitting communications to a wireless base station based on the wireless interference information as discussed herein.

As previously discussed, the separation of the mobile communication device 121 with respect to the wireless base station 131 results in a path loss of any wireless signals transmitted from the mobile communication device 121 to the wireless base station 131. The longer the distance between the mobile communication device 121 and the wireless base station 131, the greater the amount of attenuation of the transmitted wireless signals.

Techniques herein include adjusting the UE Tx power level based on Interference measured at the gNB input, where the UE transmit power may be controlled by gNB (such as wireless base station 131 and corresponding communication management resource 140) by setting different RRC and DCI parameters as given below:

$$UE Tx Power = gNB Target Rx power + pathloss factor + MCS factor + RB factor + power control command \qquad ( equation 1 )$$

In this example, the gNB Target Rx power is the desired gNB input power (signal strength) of a wireless signal received by the wireless base station 131 that is needed or desired for the wireless base station 131 to correctly decode the received wireless signal from the mobile communication device 121. In one example, the target receive power is signaled via RRC to the UE. In one example, a path loss factor (based on the distance between the wireless base station 131 and the mobile communication device 121) is communicated to the mobile communication device 121 in a respective RRC message from the wireless base station 131 to the mobile communication device 121, where the path loss factor is determined by the uplink power difference of uplink reference signal transmit power and received reference signal power. The so-called MCS (Modulation Control Scheme) factor may be communicated from the wireless base station 131 to the mobile communication device 121, where the MCS factor indicates the modulation coding scheme to be used by the mobile communication device 121. In a further example, the so-called RB (Resource Block) factor is communicated from the wireless base station 131 to the mobile communication device 121 via DCI, where the value is based on how many RBs are configured for use by the UE (mobile communication device 121). The power control command is a factor determined by the wireless base station 131 and corresponding communication management resource 140 (gNB) and is signaled via DCI to specific UEs.

In one example, according to a conventional technique, assume that the gNB Target Rx power=−105 dBm, pathloss factor=100 dBm, MCS factor=10 dBm, RB factor=15 dBm, power control command=1 dBm.

In such an instance, the UE Tx power=21 dBm=−105 dBm+100+10+15+1 (or 0, −1, +3, −3)

In contrast to conventional techniques, examples herein include implementing a respective power adjustment value at the mobile communication device 121 to account for any wireless interference detected by the wireless base station 131 (where the wireless interference is captured by the wireless interference information 151 as previously discussed). When implementing allocation of SBFD communications including SBFD symbols in different assigned timeslots such as including between time T2 in time T3, there may be increased gNB-to-gNB CLI (Cross Link Interference). As previously discussed, techniques herein include the wireless base station 131 notifying each of the different mobile communication devices of the detected wireless interference (such as communication of wireless interference information 151).

In one example, the wireless base station 131 signals to (notifies) all UEs (i.e., mobile communication devices 121, 122, 123, 124) the interference level it has detected at its wireless receiver input so that those UEs (a.k.a., mobile communication devices) can adjust their Tx power level when communicating to the wireless base station 131 in order to overcome the increased CLI (interference) caused by communications from the wireless base station 132 or other wireless base stations.

In this example, the communication system including wireless base station 131 and respective communication devices includes implementing a so-called interference factor to adjust a respective wireless signal strength/wireless power of each of the mobile communication devices transmitting in an uplink direction from those mobile communication devices to the wireless base station 131.

For example, the novel proposed Tx power (including a so-called interference factor, which is a power adjustment value based on the previously detected wireless interference of the wireless base station 131) implemented by each the mobile communication devices is given below:

$$UE Tx power = gNB Target Rx power + pathloss factor + interference factor + MCS factor + RB factor + power control command \qquad ( equation 2 )$$

In this example, the interference factor is determined by the wireless base station 131 and communication management resource 140 during a condition of not scheduling any of its UEs in the UL SBFD symbols/slots and then measuring Receive Signal Strength (RSS) in dBm at its (wireless base station 131) receiver input in order to determine the wireless interference (as indicated by the wireless interference information 151) as previously discussed. The detected level of wireless interference is the so-called interference factor (such as a power adjustment value).

In one example, the interference factor may be considered a respective noise floor as defined by the detected interference level 511 (as caused by transmission of wireless signals 311) as shown in graph 500 of FIG. 5. The signal strength adjustment value 521 (such as included in the wireless interference information 151 received by the mobile communication device 121) indicates a magnitude of the respective wireless interference noise floor such as wireless noise interference level 511. The detected noise floor as indicated by the corresponding signal strength adjustment value 521 (such as interference factor in the wireless interference information 151) is used as a basis in which to adjust a power level of wireless communications transmitted in the uplink direction from the mobile communication device 121 to the wireless base station 131 in the time slot between time T2 and time T3 and in the sub-carrier frequencies 202 of graph 171. Increasing the otherwise standard wireless power 522 by the signal strength adjustment value 521 for transmission of SBFD signals in the uplink direction from the mobile communication device 121 to the wireless base station 131 ensures that the mobile communication device 121 transmits at a sufficiently high power level that the wireless base station 131 receives such communications at a sufficient signal strength level for proper decoding.

In other words, if the mobile communication device 121 transmitted the uplink SBFD communications at the standard wireless power level 522, as previously discussed, the wireless base station 131 would not be able to retrieve corresponding data from the signals because of the noise caused by the transmission of wireless signals 311. The increase in power level such as by the interference factor (521) of the mobile communication device 121 transmitting the SBFD communications with respect to the standard wireless power 522 ensures that the wireless base station 131 receives such communications at a sufficiently high power level.

The wireless interference information 151 such as including the signal strength adjustment value 521 (a.k.a., interference factor) can be communicated to the mobile communication devices in any suitable manner.

In one example, the wireless interference information 151 and corresponding signal strength adjustment value 521 is transmitted to the UEs (mobile communication devices 121, 122, 123, 124) via DCI or MAC-CE or RRC. Alternative ways of communicating the wireless interference information 151 include communicating the new Target Rx power as gNB RX Target power+interference power (a.k.a., signal strength adjustment value 521) to the communication devices, which would eliminate the need to signal (communicate) a new parameter such as the interference factor (signal strength adjustment value 521) to the mobile communication devices. In other words, an entity such as wireless base station 131 and/or communication management resource 140 or other suitable entity can be configured to calculate a respective power level at which the mobile communication device 121 is to transmit the SBFD communications in the uplink direction using the signal strength adjustment value 521 and communicate the calculated power level to the communication device 121, which then uses the calculated power level to transmit subsequent SBFD uplink communications to the wireless base station 131.

Accordingly, the interference factor (such as power adjustment value) is basically derived based on an amount of wireless interference detected by the wireless base station 131.

In one example, according to a novel techniques as discussed herein, assume that gNB Target Rx power communicated to the mobile communication device 121=−105 dBm, pathloss factor=100 dBm, interference factor=3.5 dBm, MCS factor=10 dBm, RB factor=15 dBm, power control command=1 dBm.

$$UE Tx power = gNB Target Rx power + pathloss factor + interference factor + MCS factor + RB factor + power control command$$

In such an instance, the calculation of UE Tx power=24.5 dBm=−105 dBm+100+3.5+10+15+1 (or 0, −1, +3, −3)

Thus, according to techniques as discussed herein, instead of the mobile communication device transmitting at 21 dBm which would otherwise occur without taking into account the signal strength adjustment value 521 (+3.5 dBm), the mobile communication device transmits wireless signals (such as an uplink portion of SBFD communications) in the sub-carrier frequencies 202 at a wireless power level/signal strength of 24.5 dBm to overcome the noise floor of 3.5 dBm (previously detected wireless interference) and as indicated by the signal strength adjustment value 521.

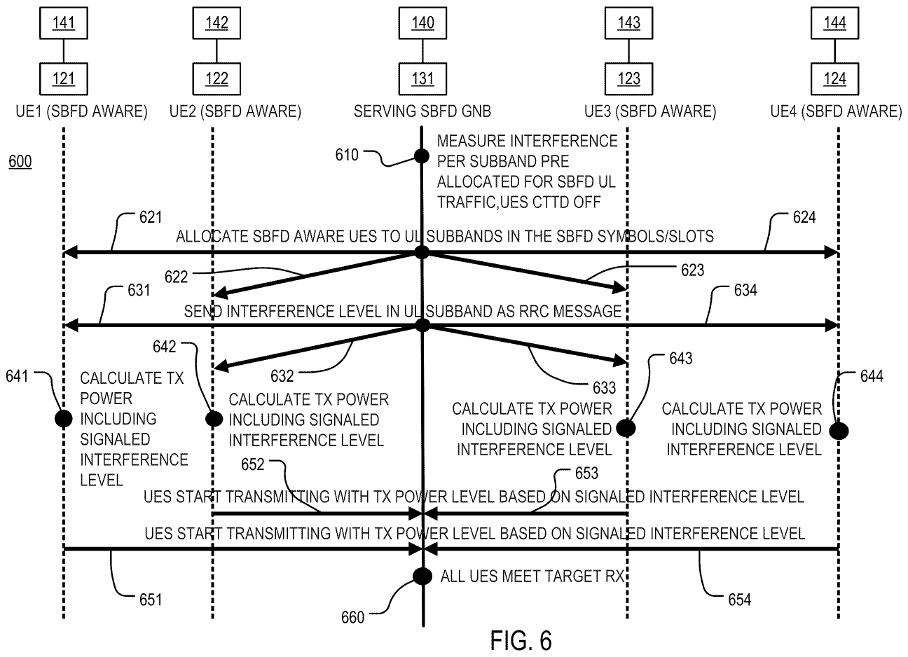

FIG. 6 is an example diagram illustrating another implementation of controlling/adjusting wireless power levels of multiple mobile communication devices transmitting SBFD communications to the wireless base station as discussed herein.

The communication flow shown in timing diagram 600 illustrates implementation of the signal strength adjustment value 521 associated with the wireless interference information 150 as previously discussed.

In this example, in processing operation 610, the wireless base station 131 (such as using the wireless channel #1 to support SBFD communications and TDD communications) temporarily prevents scheduling of uplink wireless transmissions from each of the mobile communication devices 121, 122, 123, and 124 to the wireless base station 131.

Further in processing operation 610, while the mobile communication devices are prevented from communicating (or not scheduled to communicate such as between time T1 in time T2) in the uplink direction to the wireless base station 131, the wireless base station 131 is operated in the monitor mode of detecting a respective level of wireless interference caused by one or more other wireless stations such as the wireless base station 132 transmitting wireless signals 311. Based on the detected noise/interference floor associated with detected transmission of wireless signals 311 or other wireless signals in channel #1, the wireless base station 131 and corresponding communication management resource 140 generate the wireless interference information 151 indicating the detected noise/interference floor level (such as 3.5 dBm or other amounts), which corresponds to an amount of extra wireless power/signal strength that must be added to wireless communications from the mobile communication devices in order for the wireless base station 131 to receive respective wireless communications at a sufficiently high signal strength such that the wireless base station 131 is able to accurately decipher/decode data transmitted in those respective wireless communication subsequent transmitted from the mobile communication devices to the wireless base station 131.

As previously discussed, each of the mobile communication devices 121, 122, 123, and 124, are configured to support so-called SBFD communications.

Subsequent to producing the respective wireless interference information 151, via wireless communications 621, the wireless base station 131 notifies the communication device 121 regarding allocation of one or more uplink sub-bands (such as uplink sub-frequency bands and/or downlink sub-frequency bands) and corresponding timeslots in the channel #1 for use by the mobile communication device 121 to wirelessly communicate with the wireless base station 131.

Via wireless communications 622, the wireless base station 131 notifies the communication device 122 regarding allocation of one or more uplink/downlink sub-frequency bands and corresponding timeslots in the channel #1 for use by the mobile communication device 122 to wirelessly communicate in an uplink direction to the wireless base station 131.

Via wireless communications 623, the wireless base station 131 notifies the communication device 123 regarding allocation of one or more uplink/downlink sub-frequency bands and corresponding timeslots in the channel #1 for use by the mobile communication device 123 to wirelessly communicate in an uplink direction to the wireless base station 131.

Via wireless communications 624, the wireless base station 131 notifies the communication device 124 regarding allocation of one or more uplink/downlink sub-bands and corresponding timeslots in the channel #1 for use by the mobile communication device 124 to wirelessly communicate in an uplink direction to the wireless base station 131.

Via wireless communications 631, the wireless base station 131 transmits notification of the wireless interference information 151 to the mobile communication device 121. The wireless interference information 151 may include power level adjustment information or signal strength adjustment value 521 (such as interference factor as derived from the detected wireless interference) to be applied by the mobile communication device 121 when transmitting in an uplink direction over sub-carrier frequencies 202 from the mobile communication device 121 to the wireless base station 131 in the time slot between time T2 and time T3. As discussed herein, implementation of the adjusted power information by the mobile communication device 121 ensures that the wireless base station 131 receives the subsequent wireless communications from the mobile communication device 121 at a sufficiently high signal strength.

Via wireless communications 632, the wireless base station 131 transmits notification of the wireless interference information 151 to the mobile communication device 122. The wireless interference information 151 may include power level adjustment information (such as signal strength adjustment value 521 as derived from the detected wireless interference) to be applied by the mobile communication device 122 when transmitting in an uplink direction from the mobile communication device 122 to the wireless base station 131 in a respective allocated time slot. As discussed herein, implementation of the adjusted power information by the mobile communication device 122 ensures that the wireless base station 131 receives the subsequent wireless communications from the mobile communication device 122 at a sufficiently high signal strength.

Via wireless communications 633, the wireless base station 131 transmits notification of the wireless interference information 151 to the mobile communication device 123. The wireless interference information 151 may include power level adjustment information (as derived from the detected wireless interference) to be applied by the mobile communication device 123 when transmitting in an uplink direction from the mobile communication device 123 to the wireless base station 131 in a respective assigned time slot. As discussed herein, implementation of the adjusted power information by the mobile communication device 123 ensures that the wireless base station 131 receives the subsequent wireless communications from the mobile communication device 123 at a sufficiently high signal strength.

Via wireless communications 634, the wireless base station 131 transmits notification of the wireless interference information 151 to the mobile communication device 124. The wireless interference information 151 may include power level adjustment information (as derived from the detected wireless interference) to be applied by the mobile communication device 124 when transmitting in an uplink direction from the mobile communication device 124 to the wireless base station 131 in a respective assigned time slot. As discussed herein, implementation of the adjusted power information by the mobile communication device 124 ensures that the wireless base station 131 receives the subsequent wireless communications from the mobile communication device 124 at a sufficiently high signal strength.

In processing operation 641, the mobile communication device 121 and corresponding communication management resource 141 use the received wireless interference information 150 (such as including the signal strength adjustment value 521 or interference factor) as a basis in which to determine an appropriate wireless power level of transmitting respective subsequent wireless communications from the mobile communication device 121 to the wireless base station 131.

As previously discussed, assume that the signal strength adjustment value 521 in the wireless interference information 150 indicates an adjustment value of 3.5 dBm (such as indicating a wireless interference level of detecting signals in channel #1 in processing operation 610). In such an instance, the communication management resource 141 and corresponding mobile communication device 121 implement the transmit power calculations as previously discussed in FIG. 5 to determine that subsequent wireless communications (651) from the mobile communication device 121 to the wireless base station 131 are to be transmitted at an adjusted wireless power level of 24.5 dBm instead of 21 dBm. In accordance with the transmit power calculations 24.5 dBm, the mobile communication device 121 then transmits the wireless communications 651 at the adjusted wireless power level of 24.5 dBm in the time slot between time T2 and time T3 over a first portion (202) of bandwidth in the wireless channel #1. This ensures that the wireless base station 131 is able to receive the wireless communications 651 at a sufficiently high signal strength level over the detected interference floor level to support decoding and retrieval of respective data in those transmitted wireless communication 651. During the time slot between time T2 and T3, the mobile communication device 121 receives the downlink transmitted wireless signals transmitted by the wireless base station 131 to the mobile communication device 121 in a second portion of the bandwidth and the wireless channel #1.

In processing operation 642, the mobile communication device 122 and corresponding communication management resource 142 use the received wireless interference information 151 (such as including the signal strength adjustment value 521) as a basis in which to determine an appropriate wireless power level of transmitting respective subsequent wireless communications from the mobile communication device 122 to the wireless base station 131 in an assigned timeslot and at corresponding assigned sub-carrier frequencies.

As previously discussed, assume that the signal strength adjustment value 521 in the wireless interference information 150 indicates an adjustment value of 3.5 dBm (such as based on a wireless interference level of detecting signals in channel #1 in processing operation 610). In such an instance, the communication management resource 142 and corresponding mobile communication device 122 implement the transmit power calculations as previously discussed in FIG. 5 (however, in this example, assume that the path loss factor is 101 instead of 100) to determine that subsequent wireless communications (652) from the mobile communication device 122 to the wireless base station 131 are to be transmitted at an adjusted wireless power level of 25.5 dBm instead of the otherwise standard wireless transmit power level of 22 dBm. In accordance with the transmit power calculations 25.5 dBm, the mobile communication device 122 then transmits the wireless communications 652 at the adjusted wireless power level of 25.5 dBm. This ensures that the wireless base station 131 is able to receive the wireless communications 652 at a sufficiently high signal strength level to support decoding and retrieval of respective data in those transmitted wireless communication 652.

In processing operation 643, the mobile communication device 123 and corresponding communication management resource 143 use the received wireless interference information 150 (such as including the signal strength adjustment value 521) as a basis in which to determine an appropriate wireless power level of transmitting respective subsequent wireless communications from the mobile communication device 123 to the wireless base station 131.

As previously discussed, assume that the signal strength adjustment value 521 in the wireless interference information 150 indicates an adjustment value of 3.5 dBm (such as based on a wireless interference level of detecting signals in channel #1 in processing operation 610). In such an instance, the communication management resource 143 and corresponding mobile communication device 123 implement the transmit power calculations as previously discussed in FIG. 5 (however, in this example, assume that the path loss factor is 99 instead of 100) to determine that subsequent wireless communications (653) from the mobile communication device 123 to the wireless base station 131 are to be transmitted at an adjusted wireless power level of 23.5 dBm instead of 20 dBm. In accordance with the transmit power calculations 23.5 dBm, the mobile communication device 123 then transmits the wireless communications 653 at the adjusted wireless power level of 23.5 dBm. This ensures that the wireless base station 131 is able to receive the wireless communications 653 at a sufficiently high signal strength level to support decoding and retrieval of respective data in those transmitted wireless communication 653.

In a similar manner as previously discussed, in processing operation 644, the mobile communication device 124 and corresponding communication management resource 144 use the received wireless interference information 150 to determine a respective wireless power level of transmitting the subsequent wireless signals 654 to the wireless base station 131.

Accordingly, in processing operation 660, the wireless base station 131 is able to receive the wireless SBFD communications from the different mobile communication devices at a respective desired signal strength level.

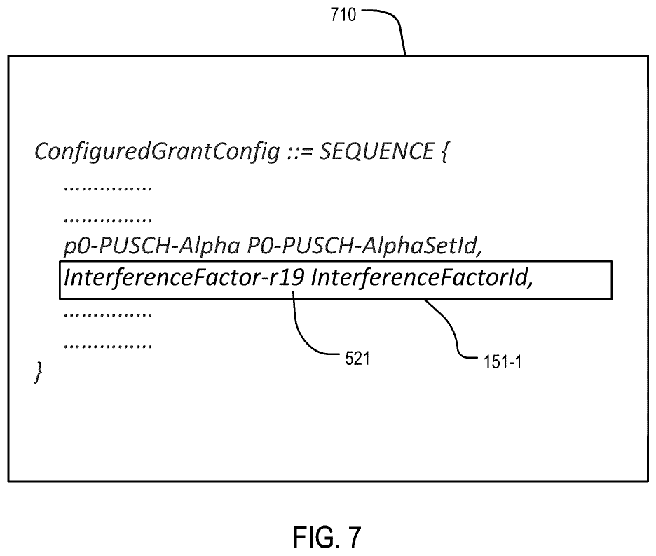

FIG. 7 is an example diagram illustrating modification of a configured to grant information element to include interference information as discussed herein.

As previously discussed, the wireless base station 131 or other suitable entity can be configured to notify the mobile communication device 121 to adjust its UE Tx (i.e., User Equipment transmit) power level when transmitting wireless signals 651 based on the wireless interference as measured at the wireless base station 131 (such as a so-called gNB) in wireless channel #1, which supports SBFD communications and non-SBFD communications (TDD communications).

It is noted that the so-called interference factor 151 (such as signal strength adjustment value 521 included in the data field 151-1 of the wireless interference information 151 supporting wireless transmit power/signal strength adjustments by the mobile communication device 121) as discussed herein may be signaled to mobile communication device 121 via so-called RRC (Radio Resource Control) signaling in the ConfiguredGrantConfig Information Element (IE) 710 such as conveyed in wireless signals 631 or other wireless signals from the wireless base station 131 to the communication device 121.

In 5G NR (New Radio), the ConfiguredGrantConfig Information Element (IE) uses RRC signaling (specifically RRCReconfiguration) to pre-configure mobile communication device 121 with semi-static uplink (uplink) resources, defining their time/frequency, periodicity, and scheduling info, bypassing dynamic DCI for uplink transmissions to reduce latency for URLLC, with parameters like timeDomainOffset, timeDomainAllocation, and frequencyDomainAllocation specifying resource locations.

The example of the information element 710 in FIG. 7 illustrates how a new ID, “InterferenceFactorID” or signal strength of adjustment value 521 stored in the data field 151-1 can be added in the current ConfiguredGrantConfig IE message 710.

In one example, the so-called interference factor (a.k.a., wireless adjustment value or signal strength adjustment value) may be an absolute interference factor or value in dBm that is calculated at the receiver input of the wireless base station 131, or the interference factor interference adjustment value may be an index to a table of pre-defined interference levels.

As previously discussed, the interference factor (521) as indicated by the wireless interference information 151 in conjunction with the determined pathloss between the wireless base station 131 and the 121 (or vice versa) may be used as a basis by the communication management resource 141 associated with the mobile communication device 121 to calculate the wireless power level (a.k.a., wireless signal strength) of the wireless signals 651 transmitted from the mobile communication device 121 to the wireless base station 131. The transmitted wireless signals 651 are transmitted at a sufficiently high power level or signal strength level to overcome the path loss between the mobile communication device 121 and the wireless base station 131 as well as the wireless interference (as indicated by the wireless interference information 151) in the channel #1 as detected by the wireless base station 131.

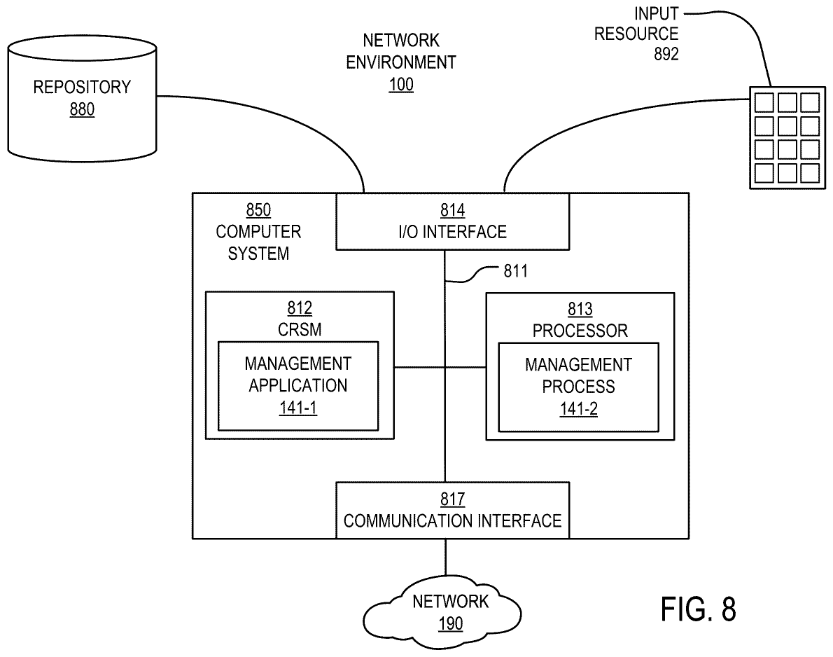

FIG. 8 is an example block diagram of a computer system for implementing any of the operations as previously discussed according to examples herein.

Note that any of the resources (such as communication management resource 140, wireless base station 131, mobile communication device 121, communication management resource 141, communication management resource 142, mobile communication device 122, communication management resource 143, mobile communication device 123, communication management resource 144, mobile communication device 124, etc.) as discussed herein can be configured to include computer processor hardware and/or corresponding executable instructions to carry out the different operations as discussed herein.

For example, as shown, computer system 850 of the present example includes interconnect 811 coupling computer readable storage media 812 such as a non-transitory type of media or computer readable storage hardware (which can be any suitable type of resource in which digital information can be stored and or retrieved), a processor 813 (computer processor hardware), I/O interface 814, and a communications interface 817.

I/O interface(s) 814 supports connectivity to repository 880 and input resource 892.

Computer readable storage medium 812 can be any hardware storage device such as memory, optical storage, hard drive, floppy disk, computer readable storage hardware, etc. In one example, the computer readable storage medium 812 stores instructions and/or data.

As shown, computer readable storage media 812 can be encoded with communication management application 141-1 in a respective one or more network nodes to carry out any of the operations as discussed herein.

During operation of one example, processor 813 accesses computer readable storage media 812 via the use of interconnect 811 in order to launch, run, execute, interpret or otherwise perform the instructions in management application 141-1 stored on computer readable storage medium 812. Execution of the management application 141-1 produces management process 141-2 to carry out any of the operations and/or processes as discussed herein.

Those skilled in the art will understand that the computer system 850 can include other processes and/or software and hardware components, such as an operating system that controls allocation and use of hardware resources to execute the management application 141-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein.

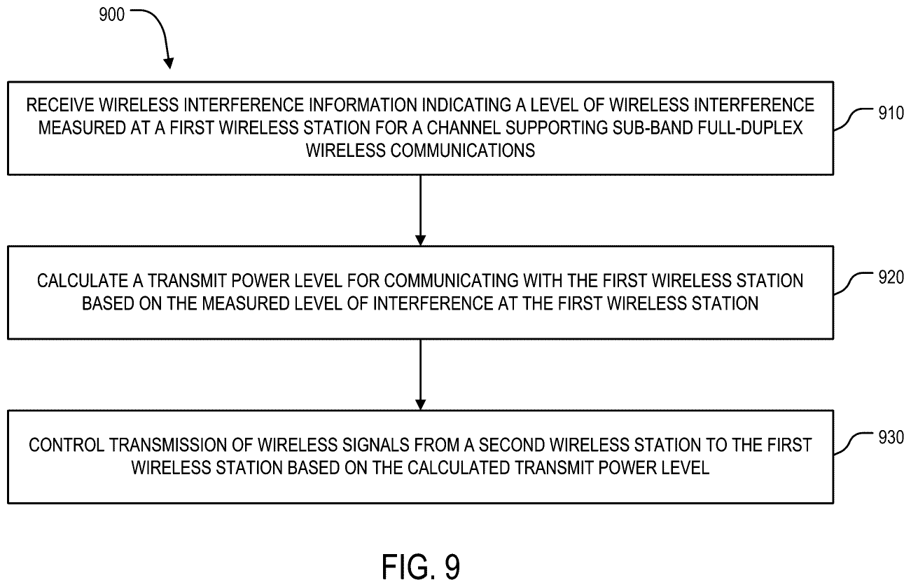

Functionality supported by the different resources will now be discussed via flowchart 900 in FIG. 9. Note that the steps in the flowcharts below can be executed in any suitable order.

FIG. 9 is a flowchart 900 illustrating an example method according to examples herein. Note that there will be some overlap with respect to concepts as discussed above.

In processing operation 910, the communication management resource 141 associated with the mobile communication device 121 receives wireless interference information 151 indicating a level of wireless interference as measured at a first wireless station (such as the wireless base station 131) for channel #1 in a first time slot. As previously discussed, the channel #1 shared by multiple wireless base stations can be configured to support any type of communications such as sub-band full-duplex wireless communications between the wireless base station 131 and the mobile communication device 121, time division duplex wireless communications between the wireless base station 132 and the mobile communication device 129, etc.

In processing operation 920, the communication management resource 141 or other suitable entity associated with the mobile communication device 121 calculates a transmit power level for communicating with the first wireless station (such as the wireless base station 131) based at least in part on the received wireless interference information 151 including one or more measured levels of interference at the first wireless station. In one example, the wireless interference information 151 indicates a wireless interference for that which the wireless base station 131 receives interfering wireless signals 311 such as transmitted from wireless base station 132.

In processing operation 930, the communication management resource 141 controls transmission of wireless signals (such as SBFD wireless signals or other wireless signals) from a second wireless station (such as the mobile communication device 121) to the wireless base station 131 based on the calculated transmit power level derived from the measured level of interference (wireless interference information 151). Thus, the presence of the wireless interference as detected by the wireless base station 131 and corresponding communication management resource 140 prompts the wireless base station 131 to notify the mobile communication device 121 (and other mobile communication devices such as communication device 122, mobile communication device 123, mobile communication device 124, etc.) to transmit SBFD communications at a respective higher wireless power level in the uplink to overcome the detected wireless interference (as caused by the wireless signals 311 or other sources) as indicated by the wireless interference information 151.

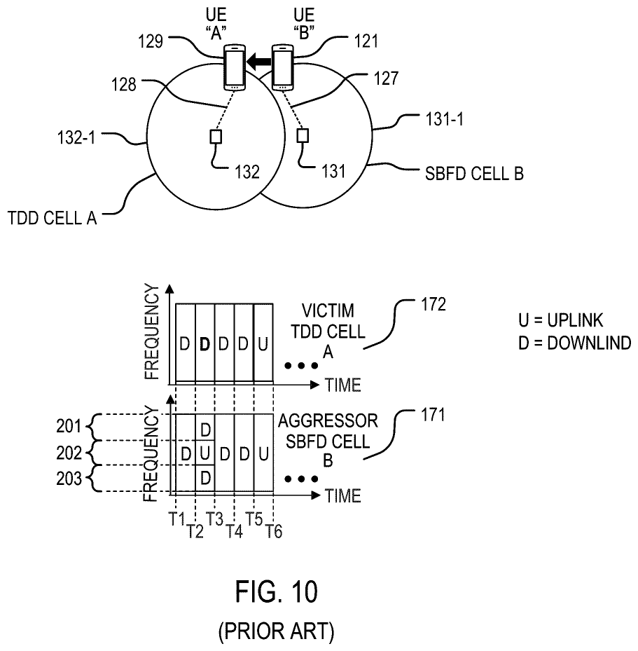

FIG. 10 is an example diagram illustrating wireless interference caused by a first mobile communication device to a second mobile communication device based on wireless transmission of SBFD communications as discussed herein.

In this example, the UE “B” such as mobile communication device 121 transmits in an uplink direction during the time slot using subcarrier frequencies between time T2 and time T3 (resource blocks), which causes adjacent cross-link interference to the TDD UE “A” such as mobile communication device 129 of a nearby TDD operator. As shown, the mobile communication device 121 also receives data transmitted in the downlink direction from the wireless base station 131 during the SBFD time slot between time T2 in time T3 using the sub-ban carrier frequencies 201 and 203. In this example, the SBFD to TDD interference is called UE-to-UE CLI (Cross Link Interference).

The level of this interference caused by transmission of the uplink communications (a.k.a., SBFD communications) is worse during a condition in which the mobile communication device 129 is very near the mobile communication device 121 and further when the two networks “A” and “B” use adjacent carrier frequencies (such as the wireless communication link 127 supporting wireless channel #1 and the wireless communication link 128 supporting corresponding adjacent wireless channel #2).

This UE-to-UE cross-link interference to the mobile communication device 129 is caused during the SBFD timeslot between time T2 and time T3 when the SBFD aggressor UE “B” is transmitting on the uplink over the wireless communication link 127 to the wireless base station 131 while the TDD victim UE “A” such as mobile communication device 129 is trying to receive downlink communications transmitted from the wireless base station 132 over the wireless communication link 128 to the mobile communication device 129.

The UE-to-UE CLI issue is worst when the two UEs (121 and 129) are located near their cell edge. For example, the aggressor UE “B” such as mobile communication device 121 is located at its own serving cell edge of the region of wireless coverage 131-1, and similarly, the victim UE “A” such as mobile communication device 129 is located at its own serving cell edge of the region of wireless coverage 132-1.

At the cell edge, the aggressor UE “B” must transmit at full wireless transmit power on the uplink over the wireless communication link 127 to the wireless base station 131, since it needs to reach its far-away base-station “B”.

At the same time, the victim UE “A” is trying to receive a weak signal such as downlink communications transmitted from the wireless base station 132 over the wireless communication link 128 at the mobile communication device 129, where the power of receiving the communications in the downlink between time T2 in time T3 as indicated by configuration 172 implemented by the network A and corresponding wireless base station 132 results in receiving a weak signal since it is transmitted from a far-away base-station “A” (a.k.a., wireless base station 132).

If the two UEs are close to each other, the UE-to-UE CLI issue can block the victim UE from receiving wireless communications from the wireless base station 132 during the said timeslot between time T2 in time T3, especially if the two networks use adjacent carrier frequencies.

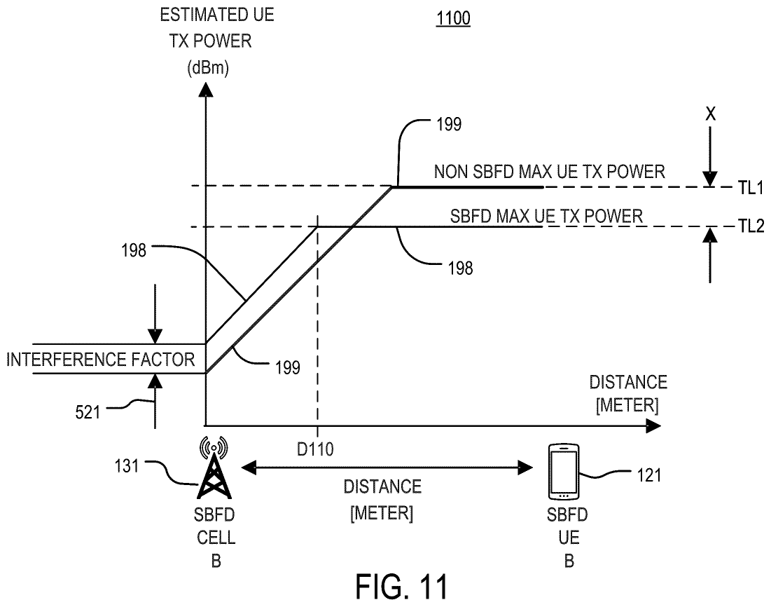

FIG. 11 is an example diagram of limiting wireless transmit power levels of different mobile communication devices transmitting SBFD communications and non-SBFD communications as discussed herein.

Graph 1100 and FIG. 11 illustrates the Estimated UE Tx power level based on Power Head Room (PHR). As the distance mobile communication device 121 and the wireless base station 131 increases, the Tx Power Level of the mobile communication device 121 communicating SBFD communications must be increased to overcome the propagation loss to meet the gNB Target Rx power level as previously discussed. In other words, the mobile communication device 121 needs to transmit the SBFD communications at the higher wireless power transit level based on the interference factor (signal strength adjustment value 521) as previously discussed. At the cell edge of the region of wireless coverage 131-1, the estimated UE Tx power of the mobile communication device 121 may be max UE Tx power level for non-SBFD communications as indicated by the curve 198. However, to reduce wireless interference as discussed herein, user equipment transmitting uplink SBFD communications are limited to transmitting at a maximum threshold level TL2, which is lower than the maximum threshold level TL1 allowed for the user equipment to transmit non-SBFD communications (such as TDD communications). It is noted that the mobile communication device 121 and wireless base station 131 support TDD communications and SBFD communications.

In one example, a controller entity such as the wireless base station 131 or communication management resource 140 or other suitable entity as discussed herein can be configured to produce a first power threshold level TL1 and a second power threshold level TL2. The controller (such as communication management resource 140 or communication management resource 141) controls conveyance of non-sub-band full-duplex wireless communications such as TDD communications over a wireless channel such that they are limited to transmission below the first power threshold level TL1. In other words, the mobile communication device 121 is able to transmit non-SBFD communications without implementing the interference factor up to a maximum wireless transmit power threshold level of TL1. The controller controls conveyance of sub-band full-duplex wireless communications over a wireless channel such that they are limited to transmission below the second power threshold level TL2, which is lower than the first power threshold TL1. In other words, the mobile communication device 121 is able to transmit SBFD communications (such as uplink communications) up to a maximum wireless transmit power threshold level of TL2.

As further discussed below, limiting the maximum magnitude of transmitting the SBFD communications in the uplink from the mobile communication device 121 to the wireless base station 131 in the timeslot between time T2 in time T3 prevents or reduces interference to the mobile communication device 129 trying to receive downlink communications transmitted from the wireless base station 132.

### Limit the Maximum Tx Power of UEs in SBFD Symbols

As previously discussed, it is noted again that the SBFD network may face additional CLI and hence may require more Tx power for the UEs using the interference factor. This additional Tx power requirement to overcome path loss and interference in the network is potentially undesirable for the battery life of the UEs and may also cause more UE-to-UE CLI in the UEs of legacy TDD adjacent channel networks. In a majority of the cases, UEs located on the respective edge of the cell are the ones that may be using maximum transmit power (PCMAX).

$$Assume that transmit power = min \{ PC MAX , Ptx \}$$

Where:

$$Ptx = Target Rx power + pathloss factor + MCS factor + RB factor + power control command$$

To overcome UE-to-UE interference as discussed herein, it is proposed to limit the maximum UE transmit power in the UL sub-bands in SBFD symbols/slots (PCMAX,SBFD) using the maximum threshold level TL2, where the maximum UE transmit power threshold level TL2 for SBFD symbols/slots (PCMAX,SBFD) is less than the maximum UE transmit power threshold level TL1 corresponding to legacy TDD UL symbols/slots ((PCMAX). However, when the mobile communication device 121 is less than the distance D110 with respect to the wireless base station 131, the mobile communication device 121 is able to transmit SBFD communications at a greater wireless power level (using the interference factor adjustment via wireless transmit power level, see curve 198) than the wireless power level (see curve 199) allowable to transmit non-SBFD communications such as TDD communications.

$$Transmit power ( non - SBFD ) = min \{ PC MAX , Ptx \}$$

$$Transmit power ( SBFD ) = min \{ PC MAX , SBFD , Ptx \}$$

Where PCMAX, SBFD=PCMAX−XdB where XdB could be from 3 dB to 6 dB as determined by gNB

By limiting the transmit power of the UEs in the SBFD symbols/slots to be less than the threshold level TL2 and using a power threshold to allow scheduling of UEs in UL sub-bands of SBFD symbols/slots, most of the cell edge UEs will not be scheduled during the SBFD symbols/slots.

In one example, the mobile communication device 121 implementing the SBFD communications can be configured to report two PHR (Power Head Room) values such as one power headroom value for non-SBFD communications and one power headroom value for SBFD communications.

One way to limit the maximum Tx power of UEs (a.k.a., mobile communication devices) is to define a new power class for SBFD PPowerClass_SBFD which will be operational for UEs in SBFD symbols/slots. Where PPowerClass_SBFD can be defined as

$$PPowerClass\_SBFD = PPowerClass - X dB , where X in dB = \{ 0 … 6 \}$$

X dB may be a selected value or signaled by gNB based on long term measurements of Cross Link Interference in the network.

Another way to limit the power of transmitting SBFD communications (a.k.a., symbols) can be to limit the PCMAX,f,c parameter by defining a new parameter

$$“ PC MAX , f , c = ” \{ ( “ PC MAX , f , c for non - SBFD symbols / slots ” or “ PC MAX , f , c - X dB ” for SBFD symbols / slots )$$

Where X in dB={0 . . . 6} which can be a predetermined value or can be signaled by gNB (a.k.a., wireless base station) based on long term measurements of Cross Link Interference in the network.

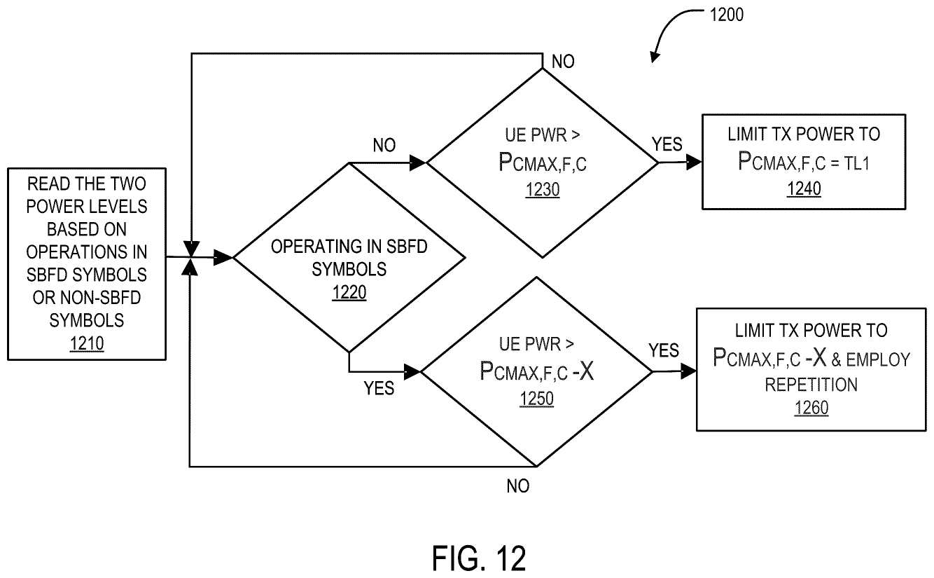

FIG. 12 is an example method of limiting different wireless transmit power levels for SBFD communications and non-SBFD communications as discussed herein.

One way to limit the maximum Tx power of UEs for SBFD communications and non-SBFD communications is to define a new power class for SBFD, namely, PPowerClass_SBFD which will be operational for wireless stations transmitting SBFD symbols/slots. In one example, the PPowerClass_SBFD may be defined as PPowerClass_SBFD=PPowerClass-X dBm, where X in dBm={0 . . . 6}. In other words, the value X (such as is the difference between threshold level TL1 and threshold level TL2, which can be any suitable selected value.

In one example, X dBm may be a predetermined value or can be signaled by gNB based on long term measurements of Cross Link Interference in the network.

Alternatively, techniques herein include limiting the PCMAX,f,c parameter by defining a new parameter such as:

$$“ PC MAX , f , c = ” \{ ( “ PC MAX , f , c for non - SBFD symbols / slots ” or “ PC MAX , f , c - X dB ” for SBFD symbols / slots )$$

In one example, “PCMAX,f,c for non-SBFD symbols/slots”=TL1 and “PCMAX,f,c-X dBm”=TL2 for SBFD symbols/slots)

Where X in dBm={0 . . . 6} which can be a predetermined value or can be signaled by gNB based on long term measurements of Cross Link Interference in the network.

As shown in flowchart 1200, processing operation 1210 includes reading two power levels based on operations in SBFD symbols or non-SBFD symbols.

Processing operation 1220 includes determining if symbols to be transmitted by the mobile communication device are SBFD symbols. If not, and it is determined that non-SBFD symbols are being transmitted by the mobile communication device 121, further processing operation 1230 includes determining whether the corresponding mobile communication device 121 is requesting to transmit the non-SBFD symbols at a power level greater than threshold level TL1. If not, the mobile communication device is able to transmit the non-SBFD symbols at the requested power level less than the threshold level TL1 and process flow continues at processing operation 1220. Conversely, if processing operation 1230 results in a determination that the requested transmit power is greater than the threshold level TL1, processing continues at processing operation 1240, where the transmit power of the mobile communication device transmitting the non-SBFD symbols is limited to transmitting such communications below the threshold level of TL1.

Alternatively, if the determination in processing operation 1220 is that the mobile communication device is transmitting SBFD symbols, processing flow continues at processing operation 1250. Processing operation 1250 includes determining if the mobile communication device 121 is attempting to transmit SBFD symbols at a wireless power level greater than the threshold level TL2. If not, the mobile communication device 121 is able to transmit the SBFD symbols. In such an instance, the mobile communication device 121 can be configured to implement the supplemental transmit power as indicated by the signal strength value 521 and corresponding interference factor in a manner as previously discussed. Conversely, if processing operation 1250 results in a determination that the requested/attempted transmit power is greater than the threshold level TL2, processing continues at processing operation 1240, where the transmit power of the mobile communication device transmitting the non-SBFD symbols is limited to the threshold level of TL2 of transmitting respective non-SBFD communications. If desired, the mobile communication device 121 can be configured to implement repetition of transmitting respective SBFD communications transmitted at the wireless transmit level TL2.

Thus, as discussed herein, during circumstances when the mobile communication device 121 is prohibited or prevented from transmitting communications above the threshold level TL2, the mobile communication device 121 is still enabled to transmit any SBFD communications at the SBFD power level as indicated by the curve 199. In such an instance, if needed, the mobile communication device 121 transmitting (TDD communications) at a wireless power level less than TL2 can be configured to implement signal repetition of transmitting respective SBFD signals in an uplink direction from the mobile communication device 121 wireless base station 131 in the time slot between time T2 and time T3. The repetition of transmitting the respective wireless signals helps to ensure that the wireless base station 131 is able to retrieve respective data in the received wireless non-SBFD signals transmitted from the mobile communication device 121.

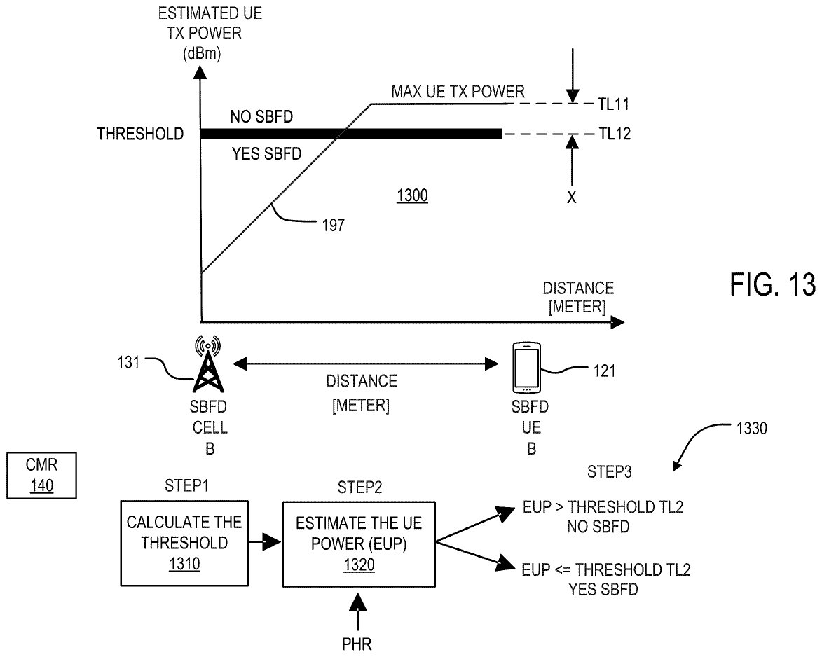

FIG. 13 is an example diagram illustrating limiting of a wireless power of transmitting SBFD communications as discussed herein.

Graph 1300 in this example illustrates how the threshold TL 12 can be generated and used to prevent a respective mobile communication device from transmitting SBFD communications above the threshold level TL12.

More specifically, FIG. 13 illustrates the Estimated UE Tx power level based on Power Head Room (PHR). As the distance between the mobile communication device 121 and the wireless base station 131 increases, the Tx Power Level (curve 197) of the mobile communication device 121 transmitting wireless signals must increase to overcome the propagation loss to meet the desired gNB Target Rx power level. At cell edge of the region of wireless coverage 131-1, the estimated UE Tx power required for wireless signals transmitted from the mobile communication device 121 is indicated by the threshold level TL11 (such as max UE Tx power level).

### Limit the Multiple Instances of User Equipment Transmitting at Maximum Tx Power Level to Only in Legacy Tdd Symbols/Slots

As mentioned, according to conventional techniques, the UE transmit power is controlled by gNB by setting different RRC and DCI parameters as given below:

$$UE Tx power = gNB Target Rx power + pathloss factor + MCS factor + RB factor + power control command .$$

As previously discussed in earlier drawings and description, when transmitting SBFD communications, this disclosure proposes to adjust this Tx power of the mobile communication device 121 to include interference factor such as the amount of wireless interference detected by the wireless base station 131.

A new proposed UE Tx power to be implemented by the mobile communication device 121 (or any other mobile communication devices as discussed herein) is given as:

$$UE Tx power = gNB Target Rx power + pathloss factor + interference factor + MCS factor + RB factor + power control command$$

With this increased Tx power based on the interference factor or signal adjustment value 521, the transmission of wireless signals from the mobile communication device 121 at the increased power level to the wireless base station 131 will ensure that the wireless base station 131 is able to decode those messages corresponding data. However, this increased power may create UE-to-UE CLI, especially by the UEs at the cell edge as they might be transmitting at their maximum Tx power level next to a UE that is trying to receive its DL transmission.

To mitigate this increased CLI in the network, one example as discussed herein proposes to not schedule (i.e., or prevent scheduling) UEs to transmit in the UL sub-bands in SBFD symbols/slots that are attempting to transmit at the maximum Tx power levels.

To achieve this, the gNB (wireless base station 131) can be configured to monitor the Power Head Room (PHR) of all the UEs in its network. PHR is calculated as below:

$$PHR = UE Maximum Transmit Power - UE Tx power used$$

Note that the PHR can be used by the gNB to estimate the UE Tx power being used by the UE as:

$$Estimated UE Tx power used = UE Maximum Transmit Power - PHR ( Step 2 or processing operation 1320 )$$

If the reported PHR (such as feedback from each respective mobile communication device) indicates to the gNB (communication management resource 140 and wireless base station 131) that the respective UE (such as mobile communication device 121) is operating close to its maximum Tx power level, then that UE (121) will not be scheduled by the gNB (131) to transmit in the UL sub-bands of the SBFD symbols/slots. The wireless base station 131 and corresponding communication management resource 140 (such as gNB) or other suitable entity can set a Tx power level threshold TL12 as below:

Threshold TL12=Maximum UE Tx power T11−XdBm (Step1 or processing operation 1320), where XdBm can be a gNB programmable parameter that may be a range from {0 to 6 dBm} and may be based on long term CLI measurement data collected by the gNB in its network and informed by its adjacent networks.

The mobile communication device 121 (whether the power transmit level is controlled by the mobile communication device 121 or the wireless base station 131 or both) is able to transmit SBFD communications at a respective power level below the threshold level TL12. The mobile communication device 121 is prevented from transmitting SBFD communications at a respective wireless power level above the threshold level TL12.

Thus, it is further noted that any instance of user equipment operating above this threshold TL12 will not be scheduled by the gNB to transmit in the UL sub-band of the SBFD symbol/slot (such as in the time slot between time T2 and time T3). However, these UEs will be allowed to receive transmission of wireless signals from the wireless base station 131 in the DL sub-bands of the SBFD symbols/slots (such as in the time slot between time T2 time T3) and allowed to transmit in the legacy TDD UL symbols/slots. (Step3 or processing operation 1330)

If gNB does schedule a UE to transmit in the UL sub-band of SBFD symbol/slot (such as in the time slot between time T2 and time T3) and, while transmitting, the Tx power level does or needs to increase, note that hysteresis may be applied to let the UE transmit above the threshold by a certain amount and if this Tx power increases a predefined tolerance level set by gNB (e.g., +1 to +1.5 dBm above threshold) then that UE is not allowed to transmit in SBFD symbols/slots but configured in UL non-SBFD symbols/slots.

Accordingly, in this example, in processing operation 1310, the communication management resource 140 or other suitable entity can be configured to calculate the threshold level TL12 associated with the transmission of SBFD communications in the network environment 100. For example, in processing operation 1310, the communication management resource generates the threshold level TL12.

In processing operation 1320, the wireless base station 131 receives power header information PHR, which indicates an available amount of extra power the mobile communication device can transmit. Additionally, in processing operation 1320, the wireless base station 131 receives the power threshold level TL12.

In further processing operation 1330, if the estimated uplink power (a.k.a., EUP) needed to transmit wireless communications from the mobile communication device 121 to the wireless base station 131 is greater than the threshold level TL12, the mobile communication device 121 is prevented from transmitting those SBFD communications. Conversely, in further processing operation 1330, if the estimated uplink power needed to transmit wireless SBFD communications from the mobile communication device 121 to the wireless base station 131 is less than the threshold level TL12, then the mobile communication device 121 is enabled to transmit and does transmit those SBFD communications.

Accordingly, as shown by the transit power curve 197 associated with the mobile communication device 121 in the graph 1300 in FIG. 13, the mobile communication device 121 is able to transmit the SBFD communications (such as in a time slot between time T2 a time T3) in an uplink direction over the wireless communication link 127 to the wireless base station 131 during conditions in which the required wireless transmit power is less than the threshold level TL12. However, at further distances from the wireless base station 131, the mobile communication device 121 is unable to transmit SBFD communications above the threshold level TL12.

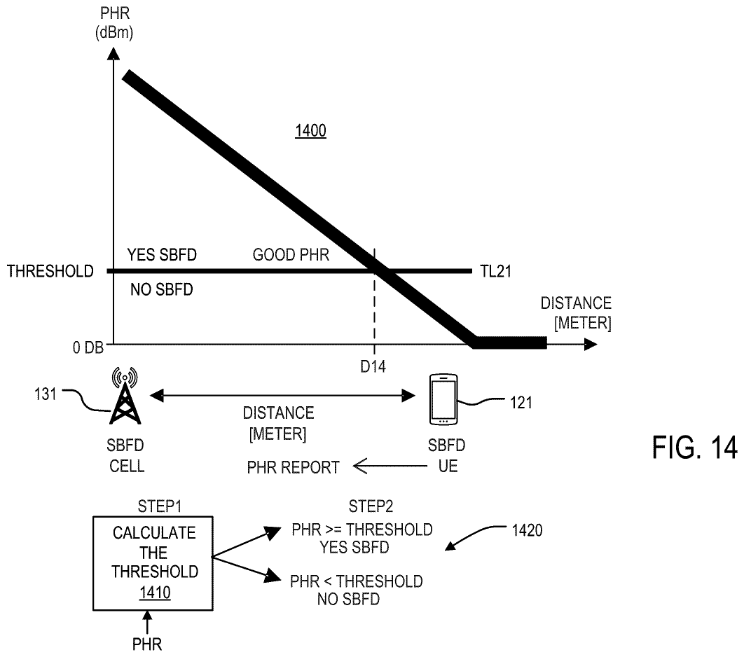

FIG. 14 is an example diagram illustrating limiting of a wireless power level of transmitting SBFD communications as discussed herein.

Graph 1400 illustrates the UE Power Head Room (PHR) relative to the distance of the mobile communication device 121 from the serving cell base station such as wireless base station 131. As the distance between the mobile communication device 121 and the wireless base station 131 increases, the PHR available for the mobile communication device 121 to transmit wireless signals to the wireless base station decreases, eventually to 0. At cell edge of the region of wireless coverage 131-1, the PHR=0 dBm or less.

This example is an extension of the example as previously discussed in FIG. 13 where the threshold can be based on the PHR fed back by the UE (121 to the wireless base station 131.

In one example, in processing operation 1410, the communication management resource produces the Threshold TL21=PHR>3 or 6 dBm.

As shown in the processing operation 1420, if PHR associated with the mobile communication device 131 is greater than the threshold level TL21 (such as because the mobile communication device 121 resides within the distance D14 of the wireless base station 131), the mobile communication device 121 will be allowed to transmit wireless signals in the SBFD symbols/slots and if PHR is less than the threshold TL21 then the mobile communication device 121 will be prevented from transmitting the wireless signals in the SBFD symbols/slots. This basically prevents the mobile communication device 121 for transmitting a wireless power levels greater than the threshold level TL12.

It is further noted that if gNB does schedule a UE (121) to transmit in the UL sub-band of SBFD symbol/slot, and while transmitting the PHR level associated with the mobile communication device 121 is reported as being below the threshold level TL21, then hysteresis may be applied to let the UE transmit for a certain amount and if this PHR decreases below a predefined tolerance level set by gNB (e.g., −1 to −1.5 dBm below threshold) then that UE is not allowed to transmit in SBFD symbols/slots but configured in legacy UL non-SBFD symbols/slots.

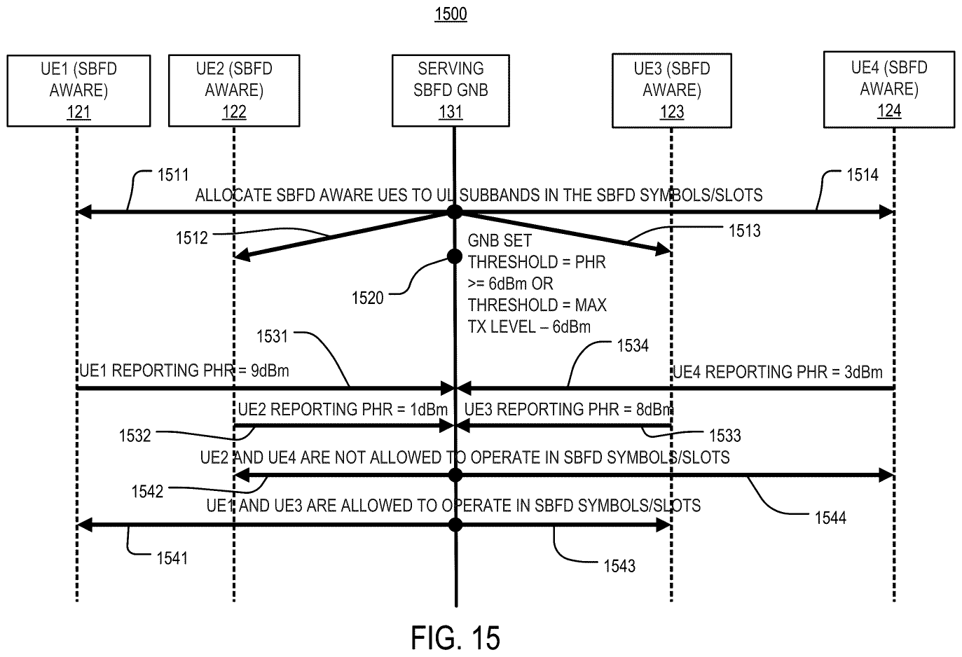

FIG. 15 is an example diagram illustrating limiting of a wireless power level of transmitting SBFD communications as discussed herein.

Graph 1500 is a signal flow diagram illustrating limitation of the UEs transmitting at maximum Tx power level to only in legacy TDD symbols/slots.

Via wireless communications 1511, the wireless base station 131 notifies the communication device 121 regarding allocation of one or more uplink sub-bands (such as uplink sub-frequency bands 202 and/or downlink sub-frequency bands 203) and corresponding timeslots in the channel #1 for use by the mobile communication device 121 to wirelessly communicate with the wireless base station 131.

Via wireless communications 1512, the wireless base station 131 notifies the communication device 122 regarding allocation of one or more uplink/downlink sub-frequency bands and corresponding timeslots in the channel #1 for use by the mobile communication device 122 to wirelessly communicate in an uplink direction to the wireless base station 131.

Via wireless communications 1513, the wireless base station 131 notifies the communication device 123 regarding allocation of one or more uplink/downlink sub-frequency bands and corresponding timeslots in the channel #1 for use by the mobile communication device 123 to wirelessly communicate in an uplink direction to the wireless base station 131.

Via wireless communications 1514, the wireless base station 131 notifies the communication device 124 regarding allocation of one or more uplink/downlink sub-bands and corresponding timeslots in the channel #1 for use by the mobile communication device 124 to wirelessly communicate in an uplink direction to the wireless base station 131.

In processing operation 1520, in a manner as previously discussed, the wireless base station 131 or other suitable entity sets the PHR threshold as follows:

$$Threshold = PHR <= 6 dBm or$$

$$Threshold = Estimated Tx level <= Max UE Tx level - 6 dBm$$

Via communications 1531, the mobile communication device 121 reports a power headroom of 9 dBm.

Via communications 1532, the mobile communication device 122 reports a power headroom of 1 dBm.

Via communications 1533, the mobile communication device 123 reports a power headroom of 8 dBm.

Via communications 1534, the mobile communication device 124 reports a power headroom of 3 dBm.

The wireless base station 131 or other suitable entity uses the respective feedback of power headroom from each of the mobile communication devices as a basis in which to determine whether or not the respective mobile communication device is allowed to transmit SBFD communications in the respective assigned SB at the time slot.

In response to such processing, the wireless base station 131 determines that the mobile communication device 121 and the mobile communication device 123 report a respective power headroom greater than the threshold level of 6 dBm. the wireless base station determines that the mobile communication device 122 and the mobile communication device 124 report a respective power headroom less than the threshold level of 6 dBm.

Accordingly, via communications 1541, the wireless base station 131 notifies the mobile communication device 121 that it is allowed to transmit wireless signals (such as SBFD symbols) in the assigned SBFD timeslot such as between time T2 and time T3.

Via communications 1543, the wireless base station 131 notifies the mobile communication device 123 that it is allowed to transmit wireless signals (such as SBFD symbols) in the assigned SBFD timeslot such as between time T2 and time T3.

Via communications 1542, the wireless base station 131 notifies the mobile communication device 122 that it is not allowed to transmit wireless signals (such as SBFD symbols) in the assigned SBFD timeslot such as between time T2 and time T3.

Via communications 1544, the wireless base station 131 notifies the mobile communication device 124 that it is not allowed to transmit wireless signals (such as SBFD symbols) in the assigned SBFD timeslot such as between time T2 and time T3.

Accordingly, based on the threshold TL12 or TL21, UE1 and UE3 are allowed to transmit in SBFD symbols or slots while UE2 and UE4 are not allowed to transmit in SBFD symbols/slots.

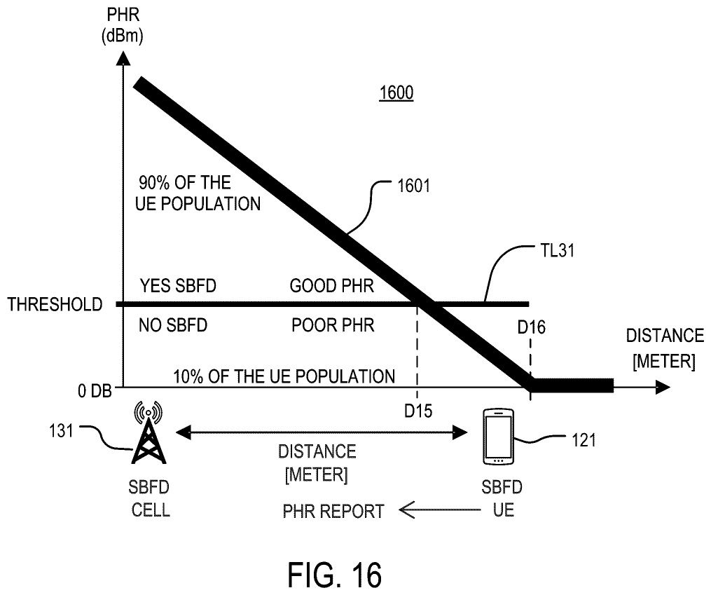

FIG. 16 is an example diagram illustrating limiting of a wireless power level of transmitting SBFD communications as discussed herein.

Graph 1600 shows the UE Power Head Room (PHR) relative to the distance from the serving cell. As the distance between the mobile communication device 121 and the wireless base station 131 increases, the PHR level available for the mobile communication device 121 to transmit in the uplink direction to the wireless base station 131 decreases. At cell edge of the region of wireless coverage 131-1, such as distance D16, the PHR available to the mobile communication device 121 is 0 dBm or less.

Techniques herein include defining to define a threshold for the UE Power Head Room (PHR) in decibels.

For example, assume that the operator associated with the SBFD network wants to sacrifice 10% of its population of user equipment that cause a lot of unnecessary retransmissions and the network service provider wants to provide more efficient service to 90% of the other UEs.

Yes SBFD in this example indicates conditions in which the power headroom associated with the mobile communication device 121 is greater than the threshold level TL31 and the corresponding mobile communication device 121 is able to transmit communications in accordance with the SBFD mode. For example, assume that the UE (121) reports its PHR in dBm to the wireless base station 131. If the received feedback of PHR associated with the mobile communication device 121 is above the threshold TL31 (near the cell the UE will not need to use its full power to reach its serving gNB and its PHR will be high), then the wireless base station 131 allows the UE to transmit normally on the UL with or without extra power during the SBFD timeslot.

No SBFD in graph 1600 indicates conditions in which the power headroom associated with the mobile communication device transmitting wireless signals is less than the threshold level TL31 because the mobile communication device 121 is further from the wireless base station 131 than the distance D15. For example, assume that the mobile communication device 121 newly reports its power headroom PHR as being below the threshold TL31 (at or near the cell edge the UE will use its maximum power and the PHR will become close to zero or less), then the wireless base station 131 will not schedule or prevent the mobile communication device 121 transmitting on the UL during the SBFD timeslot (such as between time T2 in time T3.

In one example, the level of Threshold TL31 is decided locally by the SBFD gNB such as wireless base station 131 or other suitable entity, as set by the network operator. The purpose here is to prevent unsuccessful transitions and retransmissions from cell edge UEs at full power, which could create a waste of spectrum resources and poor efficiency within the SBFD operation, while creating undesired UE-to-UE CLI issues to neighboring UEs of other adjacent networks.

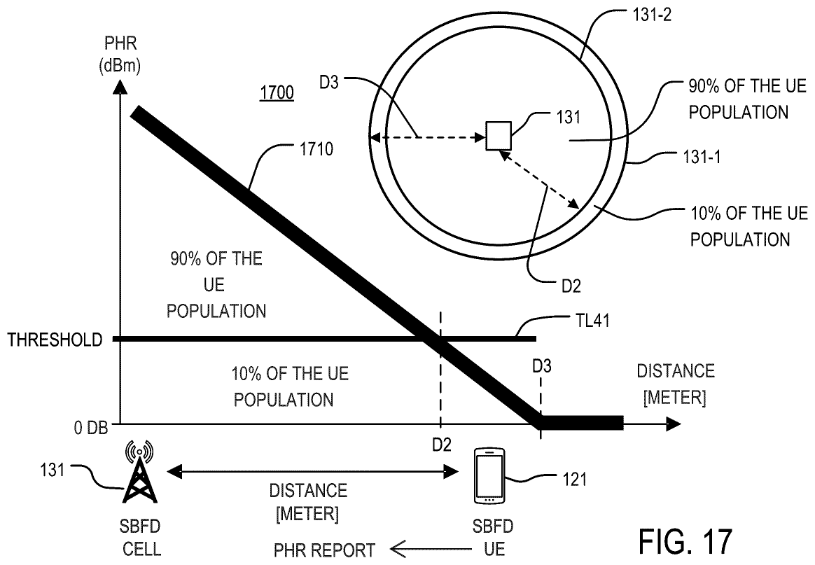

FIG. 17 is an example diagram illustrating generation/adjustment of a power transmit threshold level to control a user equipment population transmitting SBFD communications versus non-SBFD communications as discussed herein.

Graph 1700 illustrates a magnitude of power headroom 1710 available to the mobile communication device 121 to communicate with the wireless base station 131 depending on a distance of the mobile communication device 121 from the wireless base station 131. At distance D3 (such as edge of the region of wireless coverage 131-1), the mobile communication device 121 is so far away from the wireless base station 131 that it is unable to or barely able to communicate with the wireless base station 131.

Assume in this example that the SBFD operator implementing the wireless base station 131 decides to improve wireless service to 90% of its UE population by offering 90% UEs an ability to implement SBFD communications/operations, while sacrificing 10% of the population by limiting or preventing SBFD access for use by the 10% of UEs. By reducing the need for retransmissions, the overall cell efficiency of using the wireless channel #1 to support wireless communications is improved.

In this example, the operator and corresponding controller associated with the wireless base station 131 or other suitable entity sets the power headroom threshold level TL41 such that any mobile communication devices (such as 90 percent of all the UEs supported by the wireless base station 131) operating in a distance less than distance D2 from the wireless base station 131 are able to communicate SBFD communications in the uplink when scheduled.

Conversely, the operator and corresponding controller associated with the wireless base station 131 or other suitable entity sets the power headroom threshold level TL41 such that any mobile communication devices (such as 10 percent of all the UEs supported by the wireless base station 131) operating in a distance greater than distance D2 from the wireless base station 131 are not able to (prevented) communicate SBFD communications in the uplink direction to the wireless base station 131.

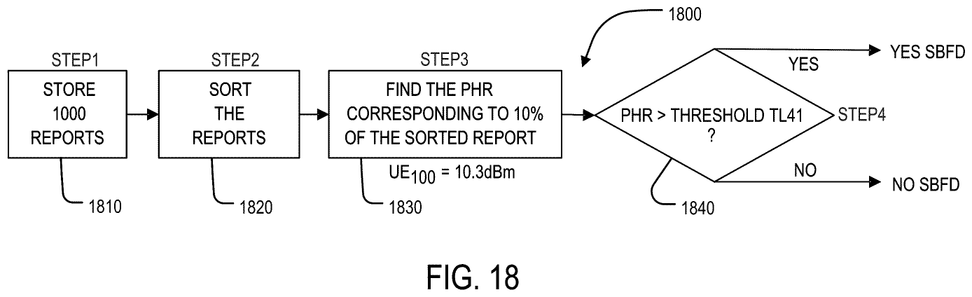

Further details of implementing the threshold level as indicated by graph 1700 resulting in the support different regions of wireless coverage for SBFD communications and non-SBFD communications is shown in FIG. 18.

FIG. 18 is an example diagram illustrating generation of a power headroom threshold level as discussed herein.

In this example, generation of the threshold level TL41 providing the 90/10 cut off as shown in flow 1800 includes the following operations:
Step1 (processing operation 1810): The SBFD gNB (a.k.a., wireless base station 131) can be configured to continuously receive power headroom reports from each of the instances of mobile communication devices connected to it. The wireless base station 131 notes the PHR reports from the most recent 1000 served UEs (a.k.a., mobile communication devices), and stores these values in ascending sort-order as follows:
{UE1=0 dBm, UE2=1.5 dBm, . . . , UE100=10.3 dBm, . . . , UE1000=20 dBm}. This indicates that UE1 has a power headroom of zero dBm; user equipment UE2 is a power headroom of 1.5 dBm; and so on.
Step2 (processing operation 1820): For goal of providing 90% of all of the UEs supported by the wireless base station 131 the ability to implement SPF the communications, it is determined that the values of the first 100 numbers are all above the threshold TL41, and the last 900 numbers are all below the threshold TL41.
Step3 (processing operation 1830): The level of Threshold TL41 is set to the power headroom value stored at element number 100 (i.e., UE100) for the 100^{th} instance of user equipment. In this example, assume that the power headroom associated with the 100^{th} instance of the user equipment is 10.3 dBm. Accordingly, the threshold level TL41 is set to 10.3 dBm.
Step4 (processing operation 1840): The wireless base station 131 and corresponding communication devices implement the threshold level TL41 such that instances of the mobile communication devices within the distance D2 of the wireless base station 131 are able to implement or communicate using SBFD allocated resources or TTD allocated resources. Conversely, corresponding communication devices further out from the wireless base station 131 greater than the distance D2 are not allowed to implement or communicate using any SBFD allocated resources. However, as previously discussed, 100 percent of the population are able to communicate using TDD communications.

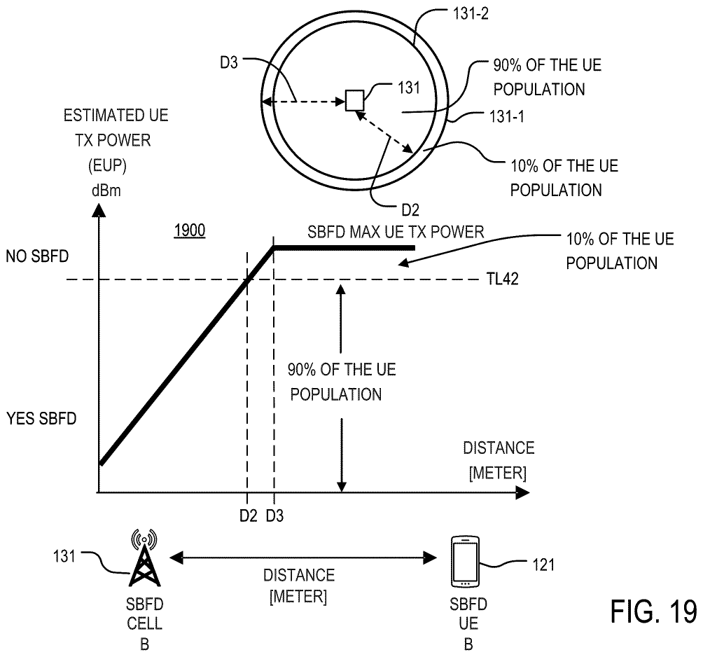

FIG. 19 is an example diagram illustrating selection/adjustment of a power threshold level to control transmission of SBFD communications as discussed herein.

Graph 1900 shows the Estimated UE Tx power level based on Power Head Room (PHR). As the distance between the mobile communication device 121 and the wireless base station 131 increases, the Tx Power Level must increase to overcome the propagation loss to meet the gNB Target Rx power level. At cell edge the estimated UE Tx power may be max UE Tx power level.

Assume in this example that the SBFD operator implementing the wireless base station 131 decides to improve wireless service to 90% of its UE population by offering that 90% the ability to implement SBFD communications/operations, while sacrificing 10% of the population by limiting or preventing SBFD access for use by that 10%. By reducing the need for retransmissions, the overall cell efficiency of using the wireless channel #1 to support wireless communications is improved.

In this example, the operator and corresponding controller associated with the wireless base station 131 or other suitable entity sets the maximum wireless transmit threshold level TL42 associated with the mobile communication device 131 transmitting wireless signals such that any mobile communication devices (such as 90 percent of all the UEs supported by the wireless base station 131) operating in a distance less than distance D2 from the wireless base station 131 are able to communicate SBFD communications in the uplink when scheduled.

Conversely, the operator and corresponding controller associated with the wireless base station 131 or other suitable entity sets the power headroom threshold level TL41 such that any mobile communication devices (such as 10 percent of all the UEs supported by the wireless base station 131) operating in a distance greater than distance D2 from the wireless base station 131 are not able to (or are prevented) communicate SBFD communications in the uplink direction to the wireless base station 131.

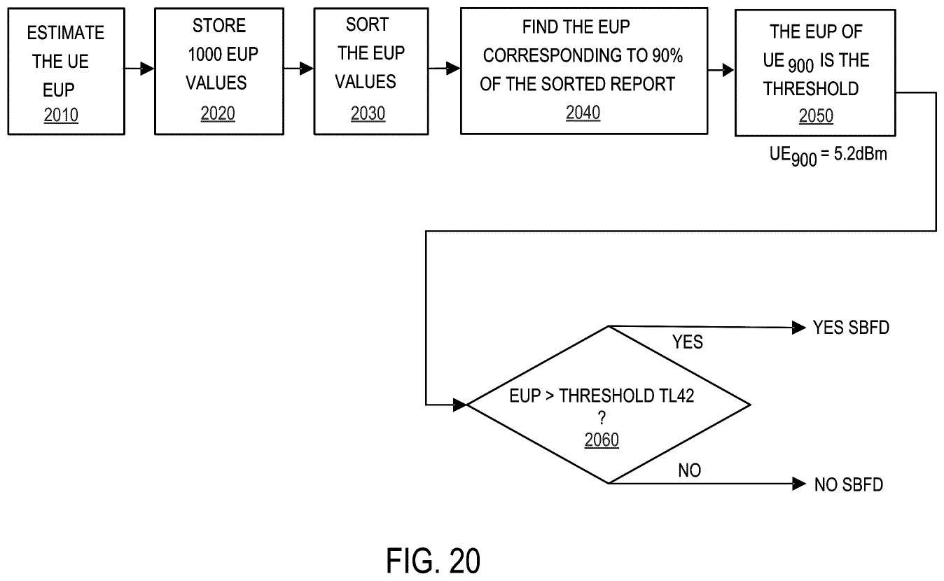

Further details of implementing the threshold level as indicated by graph 1900 resulting in the support different regions of wireless coverage for SBFD communications and non-SBFD communications is shown in FIG. 20.

FIG. 20 is an example diagram illustrating implementation of a power transmit threshold discussed herein.

In this example, instead of using power headroom, the estimated UE wireless transmit power (EUP) is in use as a basis in which to control which of the whole population of UEs is able to implement SBFD communications in which are not allowed to implement SBFD communications.

The algorithm for finding the Threshold TL42 will be similar as previously discussed, but instead of sorting the PHR reports, in this alternative the threshold level generator sorts the Estimated UE power (EUP) to determine the threshold level TL42:

$$\{ UE 1 = - 20 dBm , UE 2 = 1.5 dBm , … , UE 900 = 5.2 dBm , … , … , UE 1000 = 30 dBm \} .$$

This indicates that UE1 needs to transmit at a wireless power level of −20 dBm to communicate corresponding symbols to the wireless base station 131; user equipment UE2 needs to transmit at a wireless power level of 1.5 to communicate corresponding symbols to the wireless base station 131; and so on.

In processing operation 2010, the communication management resource 140 receives reports from each of the 1000 instances of communication devices, where the reports above indicate a wireless transmit power level associated with each of those instances of user equipment transmitting communications to the wireless base station 131.

In processing operation 2020, the communication management resource 140 stores the received 1000 sample reports and corresponding estimated transmit power levels.

In processing operation 2030, the communication management resource 140 sorts the stored sample reports and transmit power levels as above.

In processing operation 2050, the communication management resource 140 determines the magnitude of the wireless transmit power of the 90^{th} percentile of sample reports. In this case, the threshold level TL42 is selected to be 5.2 dBm because 90 percent of the UEs in communication with the wireless base station 131 transmit at a power level less than 5.2 dBm.

In other words, in this example, 90 percent of the instances of user equipment wirelessly transmit at a power level of less than 5.2 dBm to communicate with the wireless base station 131.

In processing operation 2060, the communication management resource 140 and corresponding network operator B implement the threshold level TL42 such that any of the 1000 instances of user equipment (such as those instances of user generally being within the distance D2 from the wireless base station 131) are able to transmit SBFD communications at a wireless power level of less than the threshold level TL42. Those instances of user equipment requiring a wireless power level greater than the threshold level TL42 are not allowed to transmit SBFD communications.

Accordingly, the 10 percent of the whole population of UEs transmitting at the estimated wireless power level greater than 5.2 dBm are prevented from implementing SBFD communications.

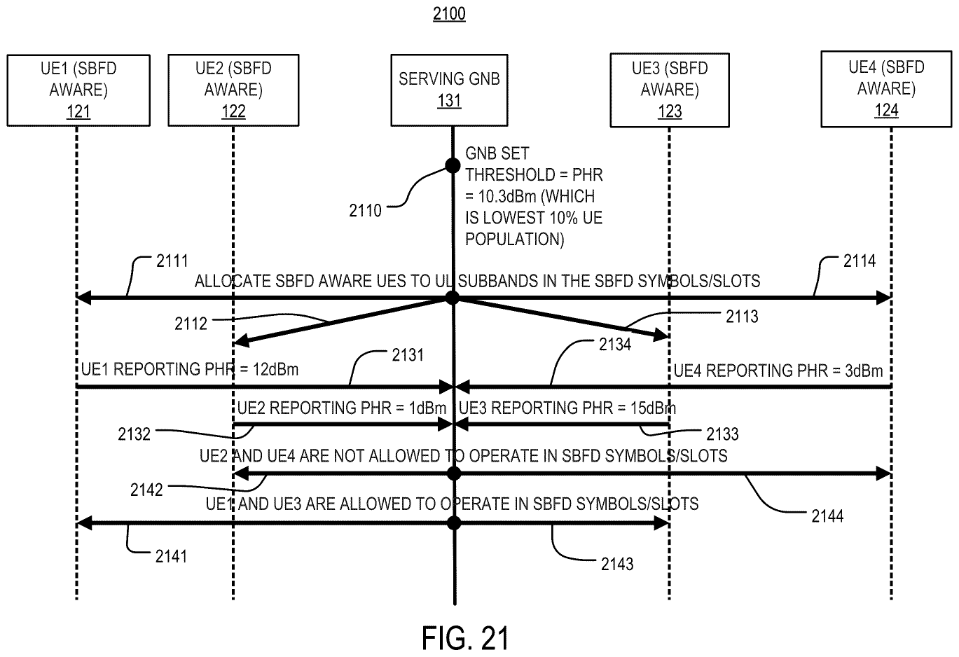

FIG. 21 is an example diagram illustrating generation/adjustment of a respective power threshold level associated with transmission of SBFD communications and non-SBFD communications as discussed herein.

Graph 2100 is a signal flow diagram illustrating limitation of the UEs transmitting at maximum Tx power level based on the threshold level TL42 as previously discussed in FIG. 18.

In processing operation 2110 as shown in FIG. 21, the wireless base station 131 or other suitable entity sets the PHR threshold TL41 to 10.3 dBm based on the 10/90 population rule as previously discussed.

Via wireless communications 2111, the wireless base station 131 notifies the communication device 121 regarding allocation of one or more uplink sub-bands (such as uplink sub-frequency bands and/or downlink sub-frequency bands) and corresponding timeslots in the channel #1 for use by the mobile communication device 121 to wirelessly communicate with the wireless base station 131.

Via wireless communications 2112, the wireless base station 131 notifies the communication device 122 regarding allocation of one or more uplink/downlink sub-frequency bands and corresponding timeslots in the channel #1 for use by the mobile communication device 122 to wirelessly communicate in an uplink direction to the wireless base station 131.

Via wireless communications 2113, the wireless base station 131 notifies the communication device 123 regarding allocation of one or more uplink/downlink sub-frequency bands and corresponding timeslots in the channel #1 for use by the mobile communication device 123 to wirelessly communicate in an uplink direction to the wireless base station 131.

Via wireless communications 2114, the wireless base station 131 notifies the communication device 124 regarding allocation of one or more uplink/downlink sub-bands and corresponding timeslots in the channel #1 for use by the mobile communication device 124 to wirelessly communicate in an uplink direction to the wireless base station 131.

Via communications 2131, the mobile communication device 121 reports a power headroom of 12 dBm.

Via communications 2132, the mobile communication device 122 reports a power headroom of 1 dBm.

Via communications 2133, the mobile communication device 123 reports a power headroom of 15 dBm.

Via communications 2134, the mobile communication device 124 reports a power headroom of 3 dBm.

The wireless base station 131 or other suitable entity uses the respective feedback of power headroom from each of the mobile communication devices in the threshold level TL41 as a basis in which to determine whether or not the respective mobile communication device is allowed to transmit SBFD communications in the respective assigned SB at the time slot.

In response to such processing, the wireless base station 131 determines that the mobile communication device 121 in the mobile communication device 123 report a respective power headroom greater than the threshold level of 10.3 dBm. the wireless base station determines that the mobile communication device 122 and the mobile communication device 124 report a respective power headroom less than the threshold level of 10.3 dBm.

Accordingly, via communications 2141, the wireless base station 131 notifies the mobile communication device 121 that it is allowed to transmit wireless signals (such as SBFD symbols) in the assigned SBFD timeslot such as between time T2 and time T3.

Via communications 2143, the wireless base station 131 notifies the mobile communication device 123 that it is allowed to transmit wireless signals (such as SBFD symbols) in the assigned SBFD timeslot such as between time T2 and time T3.

Via communications 2142, the wireless base station 131 notifies the mobile communication device 122 that it is not allowed to transmit wireless signals (such as SBFD symbols) in the assigned SBFD timeslot such as between time T2 and time T3.

Via communications 2144, the wireless base station 131 notifies the mobile communication device 124 that it is not allowed to transmit wireless signals (such as SBFD symbols) in the assigned SBFD timeslot such as between time T2 and time T3.

Accordingly, based on the threshold TL41, UE1 and UE3 are allowed to transmit SBFD symbols or slots while UE2 and UE4 are not allowed to transmit in SBFD symbols/slots.

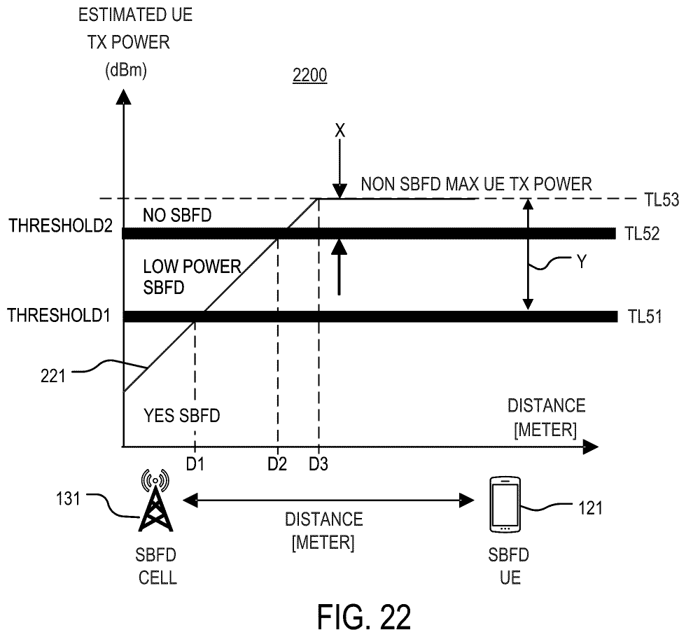

FIG. 22 is an example diagram illustrating implementation of a power threshold level to control transmission of SBFD communications and non-SBFD communications in a network environment as discussed herein.

Graph 2200 indicates the estimated transmit power level 221 required by the mobile communication device 121 to transmit communications such that the wireless base station 131 receives those communications from the mobile communication device 121 at a sufficiently high wireless power/signal strength level.

As previously discussed, the mobile communication device 121 must transmit at a higher power level (a.k.a., signal strength) to overcome the increased path loss between the mobile communication device 121 and the wireless base station 131. It is noted that at the cell edge of the region of wireless coverage 131-1, the estimated required power is at a maximum power level of TL53.

In this example, the graph 2200 further includes threshold level TL51 and threshold level TL52.

Any of the TDD-enabled mobile communication devices as discussed herein are able to transmit TDD communications at the wireless power level less than the threshold level TL53.

None of the SBFD-enabled mobile communication devices are able to transmit SBFD communications at a wireless power level greater than the threshold level TL52.

Any of the SBFD-enabled mobile communication devices as discussed herein are able to transmit low-power SBFD communications in the wireless transmit power range between the threshold level TL51 and the threshold level TL52.

Any of the SBFD-enabled mobile communication devices as discussed herein are able to transmit full SBFD communications at a power level less than the threshold level TL52.

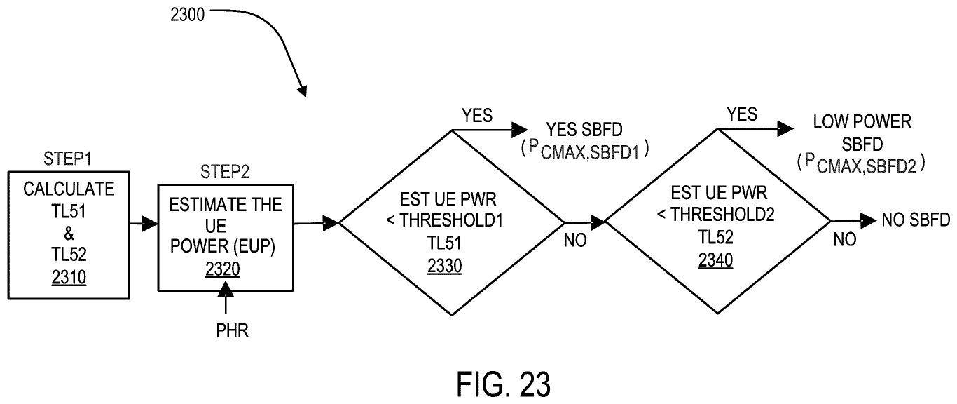

FIG. 23 is an example diagram illustrating multiple power threshold levels to control power limits associated with transmitting SBFD communications and non-SBFD communications as discussed herein.

Examples as discussed herein include implementation of the processing flow 2300 which includes defining multiple threshold levels including threshold level TL51 and threshold level TL52.

In processing operation 2310, the threshold levels are calculated as follows:

$$TL 51 = Maximum UE Tx power ( i . e . , TL 53 ) - XdBm$$

$$TL 52 = Maximum UE Tx power - YdBm$$

where XdBm and YdBm (backoffs) are based on long term measurements at gNB such that YdBm<XdBm and range could vary as

$$XdBm = \{ 6 to 9 \} and YdBm = \{ 0 to 5 \}$$

In processing operation 2320, the required power level of transmitting a communication from the mobile communication device to the wireless base station 131 is estimated.

In processing operation 2330, if the Estimated Tx power level from a UE “B” such as the mobile communication device 121 is below a threshold level TL51, the wireless base station 131 schedules/enables/controls the mobile communication device 121 to transmit SBFD communications normally on the UL sub-band during the SBFD timeslot, where the transmitted SBFD communications are transmitted at a higher power level using the normal fall magnitude of the interference factor as previously discussed.

If the Estimated Tx power level from a UE “B” is above threshold level TL51 but below a threshold level TL52 as determined in processing operation 2340, the wireless base station 131 schedules the mobile communication device 121 to transmit in the UL sub-band during the SBFD symbol/timeslot, but with a reduced maximum power level (PCMAX,SBFD), where the applied interference factor amount is less than the full amount as indicated by the signal strength adjustment value 521. The gNB (131) will specify the power reduction level based on interference measurements (RSS) and path loss from UE to gNB.

If the estimated transmit power level is greater than the threshold level TL52, the wireless base station 131 prevents the mobile communication device 121 and any other mobile communication devices from transmitting any SBFD communications.

Note that another embodiment of this could be that there may be two different maximum transmit power levels defined based on two thresholds. If UE's estimated Tx power<Threshold1 then maximum transmit power level is (PCMAX,SBFD1) and if UE's estimated Tx power is Threshold1<estimated Tx power level<Threshold2, then maximum transmit power level is (PCMAX,SBFD2), where PCMAX,SBFD1<PCMAX, SBFD2. This will ensure that UE scheduled in UL subband of SBFD symbols/slots are not increasing CLI in the network.

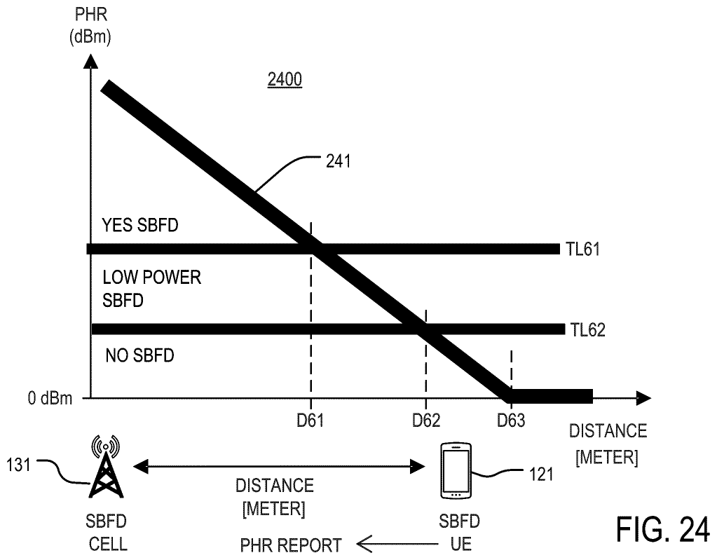

FIG. 24 is an example diagram illustrating generation of multiple power thresholds to control transmission of SBFD communications and non-SBFD communications discussed herein.

Graph 2400 shows the UE Power Head Room (PHR) of the mobile communication device 121 relative to the wireless base station 131. As the distance is increased, the available PHR level for that mobile communication device decreases. At cell edge the PHR=0 dBm or less.

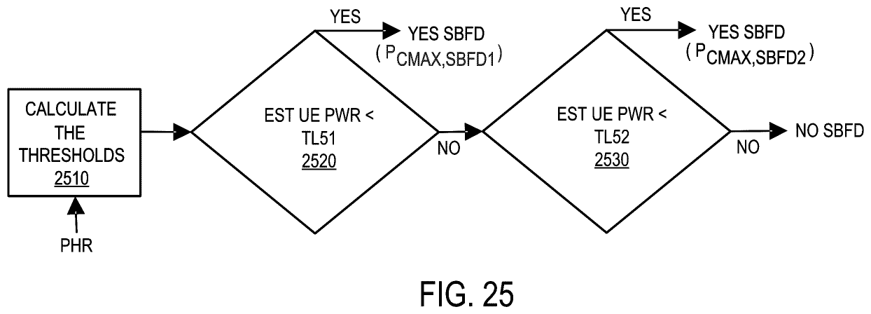

As further discussed below in FIG. 25, the wireless base station 131 or other suitable entity generates and/or implements the threshold levels TL61 and TL62 to control different power levels of the mobile communication device 121 and other mobile communication devices transmitting SBFD communications or non-SBFD communications.

For example, if the power headroom available to the mobile communication device 121 (or any other similar mobile communication device closer to the wireless base station 131 at a distance less than D61) to communicate in the uplink direction to the wireless base station 131 is greater than the threshold level TL61, then the mobile communication device 121 (and any other similar mobile communication devices within the distance D61) is able to transmit SBFD communications using the higher power level including the signal strength adjustment value 521.

If the power headroom available to the mobile communication device 121 (or any other mobile communication device residing in the distance range between distance D61 and distance D62) to communicate in the uplink direction to the wireless base station 131 is less than the threshold level TL61 but greater than the threshold level TL62, then the mobile communication device 121 (and any other mobile communication devices residing in the distance range between distance D61 and distance D62) is able to transmit SBFD communications using the lower power adjustment level including only a less than all portion of the signal strength adjustment value 521.

If the power headroom available to the mobile communication device 121 (or any other mobile communication device residing in the distance range between distance D62 and distance D63) to communicate in the uplink direction to the wireless base station 131 is less than the threshold level TL62, then the mobile communication device 121 (and any other mobile communication devices within the residing in the distance range between distance D62 and distance D63) is prevented from transmitting any transmit SBFD communications.

FIG. 25 is an example diagram illustrating generation of multiple power thresholds to control transmission of SBFD communications and non-SBFD communications as discussed herein.

In processing operation 2510, the communication management resource 140 associated with the wireless base station generates thresholds TL51 and TL52 based on FIG. 22.

$$TL 51 = PHR = X dBm , TL 52 = PHR = Y dBm$$

Where XdBm and YdBm (backoffs) are based on long term measurements at gNB such that YdBm<XdBm and range could vary as: XdBm={6 to 9} and YdBm={0 to 5}

As indicated in processing operations 2520, if received feedback of UE estimated power associated with a respective communication device is less than TL51, the respective UE will be allowed to operate (a.k.a., transmit) in the SBFD symbols/slots with full SBFD power adjustments (PCMAX,SBFD1).

If estimated UE power transmit level associated with the respective communication device is greater than TL51 the less than TL52 in processing operation 2530 then the respective UE will be allowed to operate (a.k.a., transmit) in the SBFD symbols/slots but with reduced maximum transmit power (PCMAX,SBFD2).

If the received estimated UE power transit level associated with the respective communication device is greater than TL52 then the UE will not be allowed to transmit in SBFD symbols/slots from the mobile communication device 121 to the wireless base station 131, but the mobile communication device 121 will be allowed to receive downlink communications from the wireless base station transmitted to the mobile communication device 121 in the SBFD symbols/slots.

Accordingly, with reference to FIG. 24, multiple maximum PHR levels can also be used for these thresholds such that, if a reported PHR of a UE is greater than threshold level TL61 then the respective UE is allowed to operate in SBFD symbols/slots with maximum transmit power level of PCMAX,SBFD1. If a reported power headroom of a respective mobile communication device 121 is in between the threshold TL61 and threshold TL62, then reduced maximum transmit power level of PCMAX, SBFD2 is allowed. In one example, the relationship of two power levels is PCMAX, SBFD1<PCMAX,SBFD2.

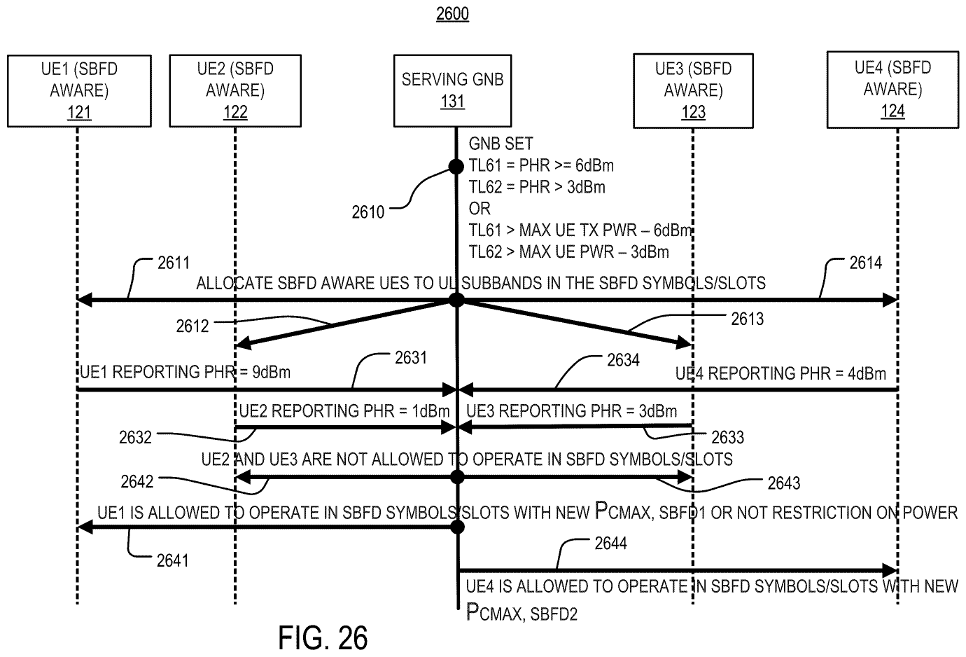

FIG. 26 is an example diagram illustrating implementation of multiple power threshold levels to control transmission of SBFD communications and non-SBFD communications as discussed herein.

In this example, the flow diagram 2600 illustrates how a network or a so-called gNB is configured to support SBFD communications. Multiple mobile communication devices 121, 122, 123, and 124, are in wireless communication with the wireless base station 131.

Assume that the mobile communication devices 121, 122, 123, 124 are all capable of supporting SBFD communications. In general, the operations in the flowchart 2600 illustrates:
1. gNB (131 and 140) allocate all four UEs to transmit in the UL sub-band of SBFD symbols/slots
2. gNB sense a threshold criteria for UEs to operate in SBFD symbols and slots as

$$TL 61 = PHR >= 6 dBm and TL 62 = PHR > 3 dBm$$

Or, in one example:

$$TL 61 = Max UE Tx pwr - 6 dBm and TL 62 = Max UE Tx pwr - 3 dBm$$

2. Each of the UEs in communication with the wireless base station 131 report back their respective power headroom. In this example, the reporting includes PHR of UE1=9 dBm, PHR of UE2=1 dBm, PHR of UE3=3 dBm and PHR of UE4=4 dBm
3. Based on the thresholds TL61 and TL62, UE2 and UE3 are allowed to transmit in SBFD symbols or slots while UE1 is allowed to transmit in SBFD symbols or slots either with reduced max transmit power of PCMAX,SBFD1 or no restriction in max Tx power level. UE4 is allowed to transmit in SBFD symbols/slots at a reduced max transmit power of PCMAX,SBFD2.

More specifically, graph 2600 is a signal flow diagram illustrating limitation of the UEs transmitting different wireless power levels based on the threshold levels.

In processing operation 2610, the wireless base station 131 or other suitable entity sets the threshold level TL61 and threshold level TL62 as shown in as previously discussed.

Via wireless communications 2611, the wireless base station 131 notifies the communication device 121 regarding allocation of one or more uplink sub-bands (such as uplink sub-frequency bands and/or downlink sub-frequency bands) and corresponding timeslots in the channel #1 for use by the mobile communication device 121 to wirelessly communicate SBFD communications to the wireless base station 131.

Via wireless communications 2612, the wireless base station 131 notifies the communication device 122 regarding allocation of one or more uplink sub-bands (such as uplink sub-frequency bands and/or downlink sub-frequency bands) and corresponding timeslots in the channel #1 for use by the mobile communication device 122 to wirelessly communicate SBFD communications to the wireless base station 131.

Via wireless communications 2613, the wireless base station 131 notifies the communication device 123 regarding allocation of one or more uplink sub-bands (such as uplink sub-frequency bands and/or downlink sub-frequency bands) and corresponding timeslots in the channel #1 for use by the mobile communication device 123 to wirelessly communicate SBFD communications to the wireless base station 131.

Via wireless communications 2614, the wireless base station 131 notifies the communication device 124 regarding allocation of one or more uplink sub-bands (such as uplink sub-frequency bands and/or downlink sub-frequency bands) and corresponding timeslots in the channel #1 for use by the mobile communication device 124 to wirelessly communicate SBFD communications to the wireless base station 131.

Via communications 2631, the mobile communication device 121 reports a power headroom of 9 dBm.

Via communications 2632, the mobile communication device 122 reports a power headroom of 1 dBm.

Via communications 2633, the mobile communication device 123 reports a power headroom of 3 dBm.

Via communications 2634, the mobile communication device 124 reports a power headroom of 4 dBm.

The wireless base station 131 and corresponding communication management resource 140 or other suitable entity use the respective feedback of power headroom from each of the mobile communication devices as a basis in which to determine whether or not the respective mobile communication device is allowed to transmit SBFD communications in the respective assigned SBFD time slot and that what power level.

Thus, in response to such processing, the wireless base station 131 determines based on the feedback power headroom values whether the mobile communication devices are able to transmit SBFD communications and, if so, at what power level.

Further in this example, via communications 2641, the wireless base station 131 notifies the mobile communication device 121 that it is allowed to transmit wireless signals (such as SBFD symbols) in the assigned SBFD timeslot in the uplink direction to the wireless base station 131 such as between time T2 and time T3 at the highest SBFD power level.

Via communications 2642, because the power headroom of the mobile communication device 122 is determined to be too low, the wireless base station 131 notifies the mobile communication device 122 that it is not allowed to transmit wireless signals (such as SBFD symbols) in the assigned SBFD timeslot such as between time T2 and time T3.

Via communications 2643, because the power headroom of the mobile communication device 122 is determined to be too low, the wireless base station 131 notifies the mobile communication device 123 that it is not allowed to transmit wireless signals (such as SBFD symbols) in the assigned SBFD timeslot such as between time T2 and time T3.

Via communications 2644, because the power headroom of the mobile communication device 124 is determined to be a mid-level between TL61 and TL62, the wireless base station 131 notifies the mobile communication device 124 that it is allowed to transmit wireless signals (such as SBFD symbols at power Pcmax, SBFD2) in the assigned SBFD timeslot such as between time T2 and time T3 at a lower SBFD power level.

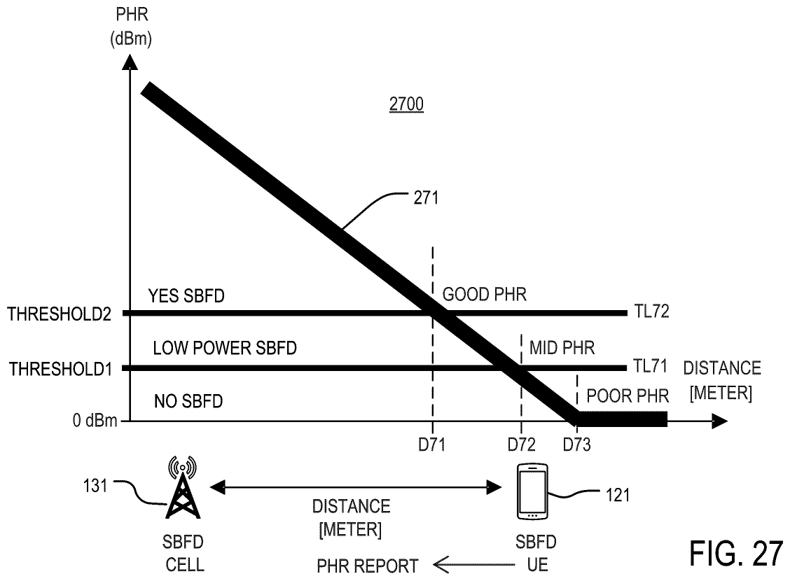

FIG. 27 is an example diagram illustrating implementation of a method of controlling a power level of transmitting SBFD and non-SBFD communications as discussed herein.

The line 271 in graph 2700 represents an available power headroom to the mobile communication device 121 depending on a distance of the mobile communication device 121 with respect to the wireless base station 131.

In this example, the graph 2700 illustrates UE Power Head Room (PHR) relative to the distance of the mobile communication device 121 from the serving cell such as the wireless base station 131. As the distance of the user equipment of the wireless base station 131 increases, the PHR level of the corresponding user equipment such as mobile communication device 121 is decreased in 64 steps. At a cell edge of the region of wireless coverage 131-1, the power headroom available to the mobile communication device 121 to communicate with the wireless base station 131 is equal to 0 dBm.

In this example, the communication management resource 140 or other suitable entity generates multiple threshold levels such as threshold level TL71 and threshold level TL72 as discussed below.

More specifically, the operator of the wireless base station 131 and corresponding network supporting SBFD communications and non-SBFD communications may desire to select the power headroom (PHR) threshold TL71 to be less than the threshold TL72 based on the total population of mobile communication devices supported by that wireless base station 131. In this example, assume that 5% of the mobile communication devices in communication with the wireless base station 131 report poor available power headroom, and another 5% report an intermediate or moderate amount of available power headroom, and the rest of the population (90%) report a good available power headroom.

In such an instance, (Yes SBFD) full power SBFD communications are allowed if the PHR of the respective user equipment is above TL72 (such as when the user equipment is near the wireless base station 131 less than the distance D71, the UE will not need to use its full power to reach its serving gNB and its PHR will be high), then the gNB will allow the corresponding UE to transmit normally (with extra power such as indicated by the signal strength adjustment value 521) on the UL during the SBFD timeslot when transmitting respective SBFD communications.

No SBFD communications are allowed if the reported PHR is below Threshold1 or threshold TL71 (at cell edge the UE or further way than the distance D72, the UE will use its maximum power and the PHR will become close to zero), then the gNB will not schedule the UE to transmit on the UL during the SBFD timeslot.

Between distance D71 in distance D72, the low power SBFD communications are allowed by the communication device 121 between Threshold1 (TL71) to Threshold2 (TL72) the gNB will schedule the UE to transmit in low power during the SBFD timeslot. The gNB (131) can be configured to specify the power reduction level based on the operator settings. In one example, the wireless base station 131 (such as SBFD gNB) transmits a new message to the mobile communication device (so-called SBFD UE) to specify the power reduction level (less than all portion of the power adjustment indicated by the signal adjustment value 521).

The threshold levels TL71 and TL72 may be locally calculated by the wireless base station 131 and corresponding communication management resource 140 or the thresholds may be selected and set by the network operator associated with the wireless base station 131.

Implementation of the reduced magnitude of wireless power of transmitting SBFD communications is to prevent unsuccessful transitions and retransmissions of communications from a mobile communication device at an edge of the region of wireless coverage 131-1 where the mobile communication devices otherwise transmitting at full power using the signal adjustment value 521. Allowing the mobile communication device 121 to transmit SBFD communications at the full possible powers previously discussed might result in a waste of spectrum resources and poor efficiency, while creating undesired UE-to-UE CLI issues to neighboring UEs of other adjacent networks. Preventing uplink SBFD communications from the mobile communication device 121 and other communication devices to the wireless base station 131 when the available power headroom of those devices is less than the threshold level TL71 reduces overall interference to those nearby instances of user equipment. Limiting a magnitude of uplink SBFD communications from the mobile communication device 121 and other communication devices to the wireless base station 131 when the available power headroom of those devices is between the threshold level TL71 and the threshold level TL72 also reduces overall interference to those nearby instances of user equipment.

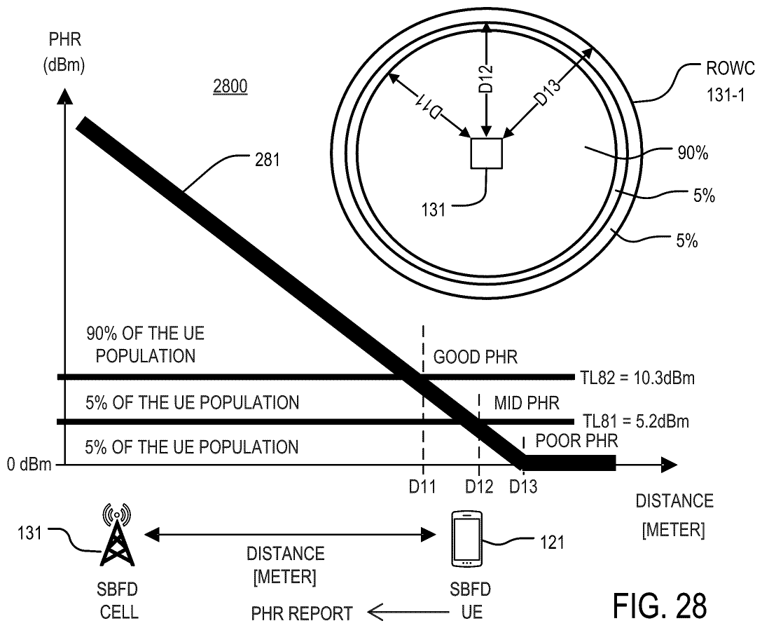

FIG. 28 is an example diagram illustrating power headroom relative to distance and implementation of multiple power threshold levels as discussed herein.

In this example, assume that the SBFD operator of the wireless base station 131 desires to improve service to 90% of its UE population by offering them the ability to transmit SBFD communications at the standard supplemental power as indicated by the signal strength adjustment value 521 if those communication devices having available power headroom greater than threshold level TL82, while sacrificing 5% of the population (communication devices having available power headroom of less than the threshold level TL81) by completely preventing such devices from transmitting any SBFD communications, and allowing only partial supplemental power adjustments (such as a less than all portion of the signal strength adjustment value 521) to transmit any SBFD communications in the uplink direction to the wireless base station 131 for any instances of mobile communication devices having an available power headroom that falls between the threshold level TL81 and threshold level TL82.

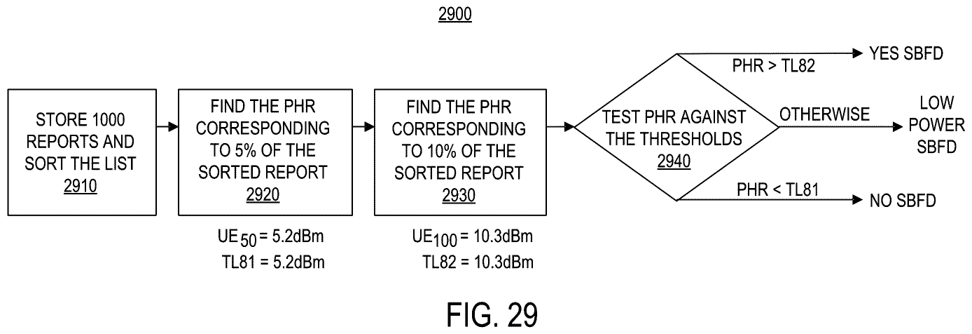

FIG. 29 is an example diagram illustrating power headroom relative to distance and implementation of multiple telephone levels as discussed herein.

In this example, the communication management resource 140 or other suitable entity overseeing the network environment 100 and corresponding network supported by the wireless base station 131 performs the following operations to generate respective threshold levels for controlling power levels of transmitting SBFD communications.

Processing operation 2910: In this example, the SBFD gNB such as the wireless base station 131 and corresponding communication management resource 140 continuously monitor the PHR reports received from the mobile communication devices served by the respective wireless base station 131. Assume that the wireless base station 131 supports wireless connectivity to 1000 instances of user equipment. The generation of the threshold levels as discussed herein may include receiving power headroom reports from each of the different instances of user equipment such as UE1, UE2, . . . , UE1000. Assume that the received power headroom information received from the instances of user equipment is ranked as follows in ascending sort-order:

$$\{ UE 1 = 0 dBm , UE 2 = 1.5 dBm , … , UE 50 = 5.2 dBm , … , UE 100 = 10.3 dBm , … , UE 1000 = 20 dBm \} .$$

In other words, the user equipment reports an available power headroom of zero dBm, the user equipment UE2 reports and available power headroom of 1.5 dBm, . . . , the user equipment UE50 reports and available power headroom of 5.2 dBm, . . . , the user equipment UE100 reports and available power headroom of 10.3 dBm, . . . . And the user equipment UE1000 reports and available power headroom of 20 dBm.

In this example, the first set of user equipment such as between UE1 and UE50 (such as 50 instances of user equipment) are further set away from the wireless base station 131 such as in a distance range between distance D12 and distance D13. The second set of user equipment such as between UE51 and UE100 (such as 50 instances of user equipment) generally reside in a distance range between distance D11 and distance D12. The third set of user equipment such as between UE100 and UE1000 (such as 900 instances of user equipment) generally reside in a distance range less than distance D11.

Processing operation 2920: For a 5% goal of preventing SBFD communications by those instances of user equipment purchased away from the wireless base station 131, the values of the available power headroom for the first 50 instances of user equipment (UE1 through UE50) are all below the threshold level TL81. The fiftieth instance of the user equipment such as UE50 corresponds to the 5 percent cut off and reports a power headroom of 5.2 dBm. Accordingly, the communication management resource 140 such as the threshold level TL81 to the value 5.2 dBm.

Processing operation 2930: The next 5% of the user equipment fall between the threshold level TL81 and the threshold level TL82, the last 900 numbers are all above both.

Thus, to achieve a 5% goal of reducing supplemental power adjustment levels associated with SBFD communications transmitted by the next 5 percent of instances of user equipment in total population includes setting the threshold level TL82 based upon the power headroom of the 100^{th} instance of user equipment such as UE100. In other words, the 100^{th} instance of the user equipment such as UE100 corresponds to the 10 percent cut off and reports a power headroom of 10.3 dBm. Accordingly, the communication management resource 140 sets the threshold level TL82 to the value 10.3 dBm.

Processing operation 2940: In this example, the wireless base station 131 allows full SBFD communications to those communication devices having the available power headroom greater than TL82. Those instances of user equipment (a.k.a., communication devices) having a power headroom available the falls between threshold TL81 and threshold TL82 are allowed to transmit SBDF communications at the reduced supplemental power level. Any of the instances of user equipment that have an available power headroom that is less than the threshold level TL81 are prevented from transmitting any SBDF communications in the uplink direction during the time slot between time T2 and time T3.

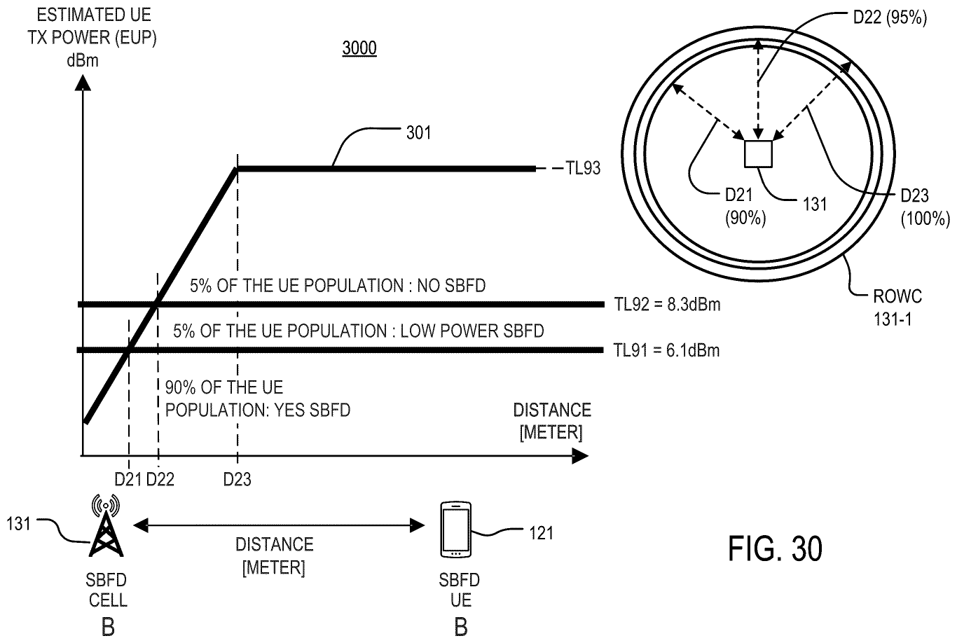

FIG. 30 is an example diagram illustrating generation of threshold levels and testing of same as discussed herein.

In this example, assume that the SBFD operator of the wireless base station 131 desires to improve service to 90% of its UE population by offering them the ability to transmit SBFD communications at the standard supplemental (extra) power as indicated by the signal strength adjustment value 521 if those communication devices are near the wireless base station 131 where the mobile communication device is able to wirelessly transmit at a power level less than the threshold level TL91, while sacrificing 5% of the population (communication devices requiring to transmit at a power level greater than threshold TL91 by completely preventing such devices from transmitting any SBFD communications, and allowing only partial supplemental power adjustments (such as a less than all portion of the signal strength adjustment value 521) to transmit any SBFD communications in the uplink direction to the wireless base station 131 for any instances of mobile communication devices transmitting in the range between the threshold level TL91 and threshold level TL92.

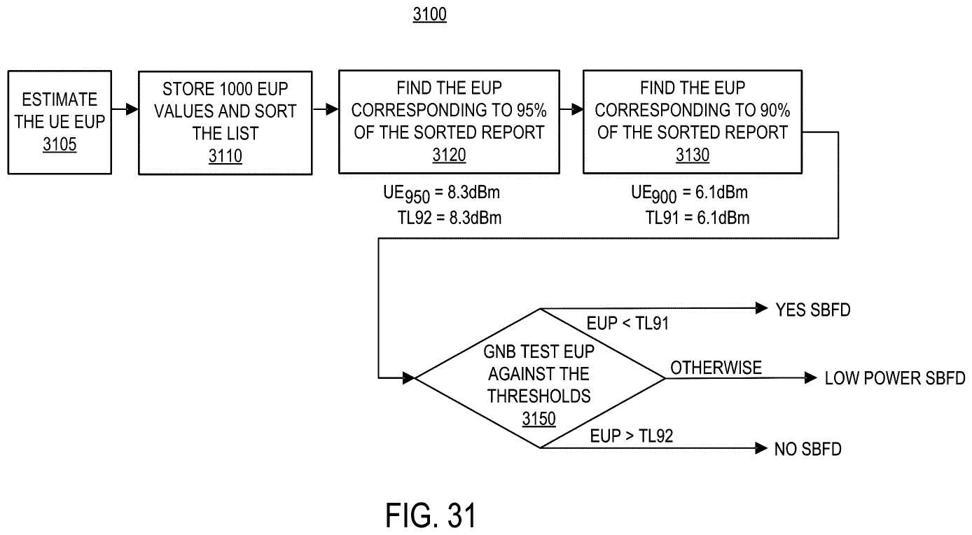

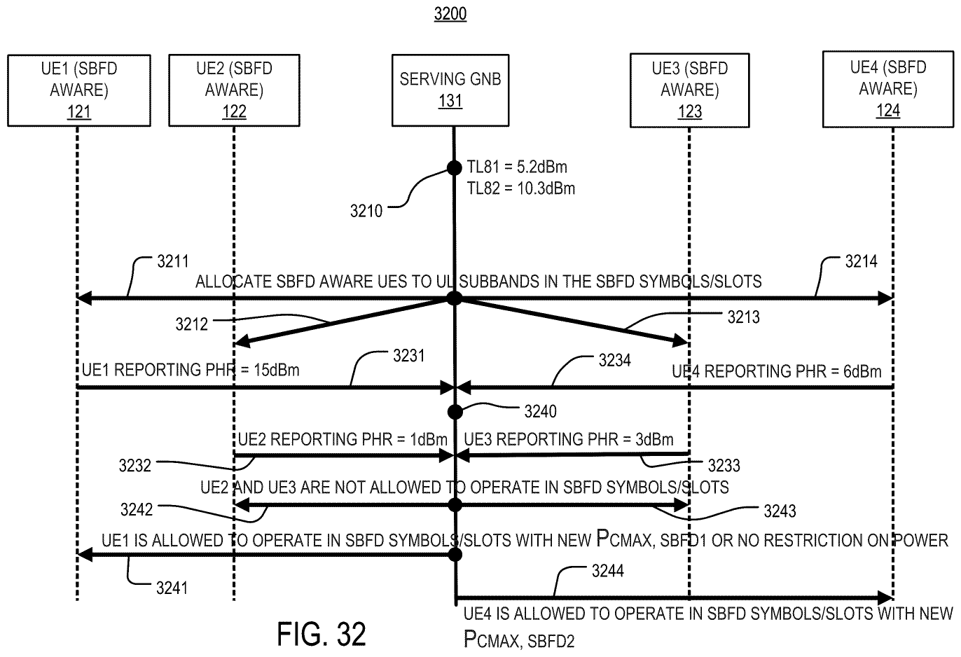

Details of producing the respective threshold levels and implementation of same are further discussed in FIG. 31 and FIG. 32

FIG. 31 is an example diagram illustrating generation of multiple threshold levels to control transmission of communications as discussed herein.

In this example, the communication management resource 140 or other suitable entity overseeing the network environment 100 and corresponding network supported by the wireless base station 131 performs the following operations to generate the respective threshold levels to control power levels of transmitting SBFD communications.

In processing operation 3105, the communication management resource 140 and corresponding wireless base station 131 receive estimates of the required transmit power level for respective communication devices (such as 1000 user equipment) to communicate in the uplink direction to the wireless base station 131.

In processing operation 3110, the SBFD supporting gNB such as the wireless base station 131 and corresponding communication management resource 140 continuously monitor the estimated power level reports received from the mobile communication devices served by the respective wireless base station 131. Assume that the wireless base station 131 supports wireless connectivity to 1000 instances of user equipment. The generation of the threshold levels as discussed herein may include receiving estimated power requirements associated with each of the different instances of user equipment to communicate in an uplink direction to the wireless base station 131, wherein the multiple instances of user equipment supply respective power headroom reports. The 1000 instances of user equipment may include user equipment such as user equipment UE1, user equipment UE2, . . . user equipment UE900, . . . . UE950, . . . , UE1000. Assume that the received transit power estimations include the following user equipment reports that are ranked as follows in ascending sort-order:

$$\{ UE 1 = - 20 dBm , UE 2 = 1.5 dBm , … , UE 900 = 6.1 dBm , … , UE 950 = 8.3 dBm , … , UE 1000 = 30 dBm \} .$$

In other words, the user equipment UE1 reports a required estimated transmit power level of −20 dBm to communicate from the respective user equipment in an uplink direction to the wireless base station 131; the user equipment UE2 reports a required estimated transmit power level of 1.5 dBm to communicate from the respective user equipment in an uplink direction to the wireless base station 131; . . . ; the user equipment UE900 reports a required estimated transmit power level of 6.1 dBm to communicate from the respective user equipment in an uplink direction to the wireless base station 131; . . . ; the user equipment UE950 reports a required estimated transmit power level of 8.3 dBm to communicate from the respective user equipment in an uplink direction to the wireless base station 131; the user equipment UE1000 reports a required estimated transmit power level of 30 dBm to communicate from the respective user equipment in an uplink direction to the wireless base station 131.

In this example, the first set of user equipment such as between UE950 and UE1000 (such as 50 instances of user equipment) are furthest away from the wireless base station 131 such as in a distance range between distance D22 and distance D23. The second set of user equipment such as between UE900 and UE950 (such as 50 instances of user equipment) generally reside in a distance range between distance D21 and distance D22. The third set of user equipment such as between UE1 and UE900 (such as 900 instances of user equipment) generally reside in a distance range between zero and distance D21 from the wireless base station 131.

In processing 3120, based on a goal of preventing SBFD communications by the top 5% of those instances of user equipment between distance D22 and D23 (95^{th} percentile to 100^{th} percentile) away from the wireless base station 131, the values of the estimated required uplink power level of transmitting indications for all greater than the threshold level TL92 such as 8.3 dBm. The 950^{th} instance of the user equipment such as UE950 and power level of 8.3 dBm corresponds to the 5 percent cut off (top 5 percent of total population of user equipment). Accordingly, the communication management resource 140 assigns the value 8.3 dBm to the threshold level TL92.

In processing 3130, based on a goal of preventing SBFD communications by a next top 5% of those instances (between the 90^{th} percentile and the 95^{th} percentile) of user equipment between distance D21 and D22 away from the wireless base station 131, the values of the estimated required uplink power level of transmitting communications for such UEs is greater than the threshold level TL91 such as 6.1 dBm. The 900^{th} instance of the user equipment such as UE900 corresponds to the 10 percent cut off or the 90^{th} percentile of the total user equipment population of 1000 UEs. Accordingly, the communication management resource 140 assigns the value 6.1 dBm to the threshold level TL91.

In processing operation 3150, the wireless base station 131 and corresponding communication management resource 140 control transmission of SBFD communications based on the threshold levels TL91 (90^{th} percentile of the total population) and TL92 (95^{th} percentile of the total population). More specifically, the wireless base station 131 prevents any of the communication devices (such as user equipment UE950 through user equipment UE100 or 95^{th} percentile to 100^{th} percentile) from transmitting SBFD communications at a power level greater than the threshold level TL92 (corresponding to a distance of UEs generally between distance D22 and distance D23). The wireless base station 131 controls the instances of user equipment such as between UE900 and UE950 (90^{th} percentile to 95^{th} percentile generally between distance D21 and distance D22) to transmit SBFD communications at a reduced power level (such as a less than all portion of the total signal strength adjustment value 521). The wireless base station 131 controls the instances of user equipment UE1 through user equipment UE900 to transmit SBFD in communications at the full power level as indicated by the interference factor or signal strength adjustment value 521.

FIG. 32 is an example diagram illustrating a method of generating multiple threshold levels to control transmission of communications as discussed herein.

Graph 3200 is a signal flow diagram illustrating limitation of the UEs transmitting at different maximum power levels as discussed herein. The discussion below and corresponding processing operations correspond to the discussion in FIG. 28 and FIG. 29.

In processing operation 3210 in graph 3200, as previously discussed in FIG. 29, the wireless base station 131 or other suitable entity sets the PHR thresholds such as threshold TL81=5.2 dBm corresponding to 90 percent (90^{th} percentile) of the total population of UEs and threshold TL82=10.3 dBm corresponding to 95 percent (95^{th} percentile) of the total population of UEs serviced by the wireless base station 131.

Via wireless communications 3211, the wireless base station 131 notifies the communication device 121 regarding allocation of one or more uplink sub-bands (such as uplink sub-frequency bands and/or downlink sub-frequency bands) and corresponding timeslots in the channel #1 for use by the mobile communication device 121 to wirelessly communicate with the wireless base station 131.

Via wireless communications 3212, the wireless base station 131 notifies the communication device 122 regarding allocation of one or more uplink/downlink sub-frequency bands and corresponding timeslots in the channel #1 for use by the mobile communication device 122 to wirelessly communicate in an uplink direction to the wireless base station 131.

Via wireless communications 3213, the wireless base station 131 notifies the communication device 123 regarding allocation of one or more uplink/downlink sub-frequency bands and corresponding timeslots in the channel #1 for use by the mobile communication device 123 to wirelessly communicate in an uplink direction to the wireless base station 131.

Via wireless communications 3214, the wireless base station 131 notifies the communication device 124 regarding allocation of one or more uplink/downlink sub-bands and corresponding timeslots in the channel #1 for use by the mobile communication device 124 to wirelessly communicate in an uplink direction to the wireless base station 131.

Via communications 3231, the mobile communication device 121 reports a power headroom of 15 dBm available to communicate with the wireless base station 131.

Via communications 3232, the mobile communication device 122 reports a power headroom of 1 dBm available to communicate with the wireless base station 131.

Via communications 3233, the mobile communication device 123 reports a power headroom of 3 dBm available to communicate with the wireless base station 131.

Via communications 3234, the mobile communication device 124 reports a power headroom of 6 dBm available to communicate with the wireless base station 131.

The wireless base station 131 or other suitable entity uses the respective feedback of power headroom from each of the mobile communication devices and corresponding processing operation 3240 as a basis in which to determine whether or not the respective mobile communication device is allowed to transmit SBFD communications and at what power level in the respective assigned SBFD time slot. Any mobile communication devices having a power headroom of less than 5.2 dBm are not allowed to transmit any SBFD communications; any mobile communication devices having a power headroom of between 5.2 dBm and 10.3 dBm are allowed to transmit the SBFD communications at a reduced SBFD power level (such as a regular or conventional power transmit level plus only a portion of the maximum signal strength adjustment value 521); any mobile to communication devices having a power headroom of more than 10.3 dBm are allowed to transmit SBFD communications at the full or maximum possible SBFD power level using the signal strength adjustment value 521.

In response to such processing, the wireless base station 131 determines that the mobile communication device 121 reports a respective power headroom of 15 dBm, which is greater than the threshold level TL82. In such an instance, the mobile communication device 121 is able to transmit SBFD communications at the full SBFD power level using the interference factor. Accordingly, via communications 3241, the wireless base station 131 notifies the mobile communication device 121 that it is allowed to transmit wireless signals (such as SBFD symbols) in the assigned SBFD timeslot such as between time T2 and time T3 or other time slot at the full available SBFD power level using the additional power as indicated by the signal strength adjustment value 521.

In response to such processing, the wireless base station 131 determines that the mobile communication device 122 reports a respective power headroom of 1 dBm, which is less than the threshold level TL81. In such an instance, the mobile communication device 122 is not able to transmit SBFD communications at any SBFD power level. Accordingly, via communications 3242, the wireless base station 131 notifies the mobile communication device 122 that it is not allowed to transmit any SBFD wireless signals in the uplink direction to the wireless base station 131 between time T2 and time T3.

In response to such processing, the wireless base station 131 determines that the mobile communication device 123 reports a respective power headroom of 3 dBm, which is less than the threshold level TL81. In such an instance, the mobile communication device 123 is not able to transmit SBFD communications at any SBFD power level. Accordingly, via communications 3243, the wireless base station 131 notifies the mobile communication device 123 that it is not allowed to transmit any SBFD wireless signals in the uplink direction to the wireless base station 131 between time T2 and time T3.

In response to such processing, the wireless base station 131 determines that the mobile communication device 124 reports a respective power headroom of 6 dBm, which is in between the threshold TL81 and the threshold level TL82. In such an instance, the mobile communication device 124 is able to transmit SBFD communications at the reduced supplemental SBFD power level. Accordingly, via communications 3241, the wireless base station 131 notifies the mobile communication device 124 that it is allowed to transmit wireless signals (such as SBFD symbols) in the assigned SBFD timeslot such as between time T2 and time T3 at the reduced available SBFD power level. In other words, the mobile communication device 124 is able to transmit in a timeslot between time T2 in time T3 in the uplink direction to the wireless base station 131 at a wireless power level including a less than all portion of the signal strength adjustment value 521.

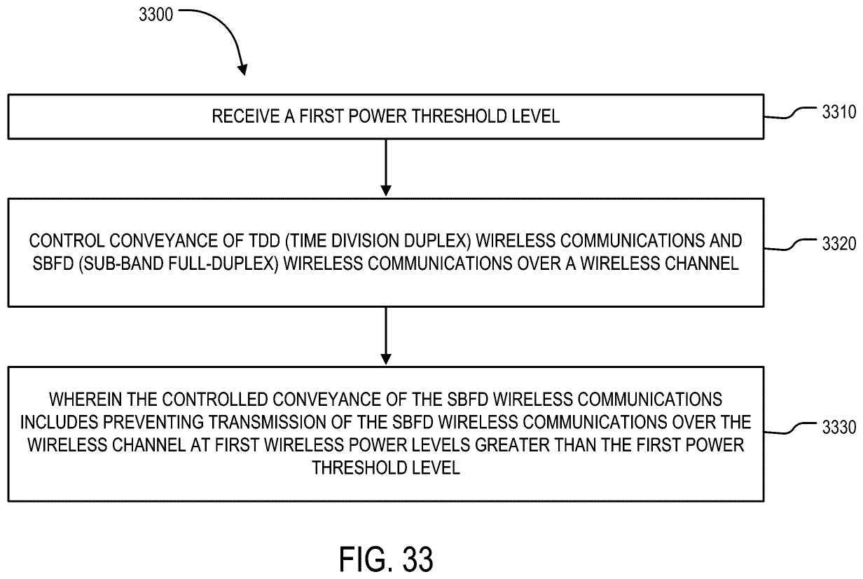

FIG. 33 is an example method of controlling transmission of communications as discussed herein.

As previously discussed, the wireless base station 131 or other suitable entity can be configured to schedule transmission of communications in the network environment 100 by its corresponding mobile communication devices.

As shown in processing operation 3310 of flowchart 3300, the wireless base station 131 (and corresponding communication management resource 140) receive or generate a first power threshold level such as transmit power threshold level TL12 in FIG. 13.

In processing operation 3320, the wireless base station 131 and/or mobile communication device 121 control conveyance of TDD (Time Division Duplex) wireless communications and SBFD (Sub-Band Full-Duplex) wireless communications over a wireless channel #1.

In processing operation 3330, the controlled conveyance of the SBFD wireless communications includes preventing transmission of the SBFD wireless communications over the wireless channel #1 at first wireless power levels greater than the first power threshold level TL12.

Note again that techniques herein are well suited to support better coexistence of multiple wireless stations supporting sub-band full-duplex communications and time division duplex communications over a same wireless channel. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical, electronic, or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are present in the following claims.

We claim:

1. A method comprising:
receiving wireless interference information indicating a level of wireless interference in a first wireless channel as measured at a first wireless station, the first wireless channel supporting sub-band full-duplex wireless communications;
calculating a transmit power level for communicating with the first wireless station based on the measured level of interference at the first wireless station; and
controlling transmission of wireless signals over the first wireless channel from a second wireless station to the first wireless station based on the calculated transmit power level.

2. The method as in claim 1, wherein the first wireless station provides wireless connectivity to a first set of wireless stations including the second wireless station; and
wherein the level of wireless interference is measured at the first wireless station during a condition in which the wireless stations in the first set are prevented from wirelessly transmitting signals in the first wireless channel.

3. The method as in claim 2, wherein the wireless interference measured at the first wireless station is caused at least in part by a third wireless station wirelessly communicating messages to a fourth wireless station.

4. The method as in claim 3, wherein the messages are wirelessly communicated over a second wireless channel, the second wireless channel being a non-sub-band full-duplex wireless channel.

5. The method as in claim 1, wherein the measured level of wireless interference indicates a wireless interference power level; and
wherein calculating the transmit power level includes: i) generating a base transmit power level; and ii) producing an adjusted base transmit power level via increasing the base power transmit level by at least an amount as indicated by the wireless interference power level.

6. The method as in claim 1, wherein controlling transmission of the wireless signals from the second wireless station includes:
transmitting the wireless signals from the second wireless station over the first wireless channel to the first wireless station, the wireless signals transmitted from the second wireless station at the calculated transmit power level.

7. The method as in claim 1, wherein the wireless signals transmitted from the second wireless station are received at the first wireless station at a greater wireless power level than the measured level of wireless interference at the first wireless station.

8. The method as in claim 1, wherein the wireless interference information is transmitted from the first wireless station to the second wireless station; and
wherein the transmit power level for communicating with the first wireless station is calculated at the second wireless station.

9. The method as in claim 1, wherein controlling transmission of the wireless signals from the second wireless station to the first wireless station includes:
assigning the second wireless station a time slot in which to transmit the wireless signals over the first wireless channel to the second wireless station;
assigning the second wireless station in a first bandwidth portion of the first wireless channel to transmit the wireless signals; and
notifying the second wireless station of the assigned time slot and the first bandwidth portion in which to transmit the wireless signals from the second wireless station to the first wireless station.

10. The method as in claim 9, wherein the wireless signals are first wireless signals; and
wherein controlling transmission of the wireless signals from the second wireless station to the first wireless station based on the calculated transmit power level includes: during the assigned time slot, receiving the wireless signals transmitted from the second wireless station, the wireless signals transmitted in the first bandwidth portion of the first wireless channel, the method further comprising:
during the assigned time slot, transmitting second wireless signals from the first wireless station over a second bandwidth portion of the first wireless channel.

11. A system comprising:
communication management hardware operative to:
receive wireless interference information indicating a level of wireless interference in a first wireless channel as measured at a first wireless station, the first wireless channel supporting sub-band full-duplex wireless communications;
calculate a transmit power level for communicating with the first wireless station based on the measured level of wireless interference at the first wireless station; and
control transmission of wireless signals over the first wireless channel from a second wireless station to the first wireless station based on the calculated transmit power level.

12. The system as in claim 11, wherein the first wireless station provides wireless connectivity to a first set of wireless stations including the second wireless station; and
wherein the level of wireless interference is measured at the first wireless station during a condition in which the wireless stations in the first set are prevented from wirelessly transmitting signals in the first wireless channel.

13. The system as in claim 12, wherein the wireless interference measured at the first wireless station is caused at least in part by a third wireless station wirelessly communicating messages to a fourth wireless station.

14. The system as in claim 13, wherein the messages are wirelessly communicated over a second wireless channel, the second wireless channel being a non-sub-band full-duplex wireless channel.

15. The system as in claim 11, wherein the measured level of wireless interference indicates a wireless interference power level; and
wherein the communication management hardware is further operative to: i) generate a base transmit power level; and ii) produce an adjusted base transmit power level via increasing the base power transmit level by at least an amount as indicated by the wireless interference power level.

16. The system as in claim 11, wherein the communication management hardware is further operative to:
transmit the wireless signals from the second wireless station over the first wireless channel to the first wireless station, the wireless signals transmitted at the calculated transmit power level.

17. The system as in claim 11, wherein the wireless signals transmitted from the second wireless station are received at the first wireless station at a greater wireless power level than the measured level of wireless interference at the first wireless station.

18. The system as in claim 11, wherein the wireless interference information is transmitted from the first wireless station to the second wireless station; and
wherein the transmit power level for communicating with the first wireless station is calculated at the second wireless station.

19. The system as in claim 11, wherein the communication management hardware is further operative to:
assigned the second wireless station a time slot in which to transmit the wireless signals over the first wireless channel to the second wireless station;
assigned the second wireless station in a first bandwidth portion of the first wireless channel to transmit the wireless signals; and
notify the second wireless station of the assigned time slot and the first bandwidth portion in which to transmit the wireless signals.

20. The system as in claim 19, wherein the wireless signals are first wireless signals; and
wherein the communication management hardware is further operative to during the assigned time slot: i) receiving the wireless signals transmitted from the second wireless station, the wireless signals transmitted in the first bandwidth portion of the first wireless channel, and ii) transmitting a second wireless signals from the first wireless station over a second bandwidth portion of the first wireless channel.

21. Computer-readable storage hardware having instructions stored thereon, the instructions, when carried out by computer processor hardware, cause the computer processor hardware to:
receive wireless interference information indicating a level of wireless interference in a first wireless channel as measured at a first wireless station, the first wireless channel supporting sub-band full-duplex wireless communications;
calculate a transmit power level for communicating with the first wireless station based on the measured level of interference at the first wireless station; and
control transmission of wireless signals over the first wireless channel from a second wireless station to the first wireless station based on the calculated transmit power level.
